(19) United States
(12) Patent Application Publication
(10) Pub. No.: US 2026/0037037 A1
(43) Pub. Date: Feb. 5, 2026

(54) WINDOW AND ELECTRONIC DEVICE INCLUDING THE SAME

(71) Applicant: Samsung Display Co., LTD., Yongin-si (KR)

(72) Inventors: HYUNJI LEE, Yongin-si (KR); JINGYU SIM, Yongin-si (KR); BYUNGHOON KANG, Yongin-si (KR); SANGHOON KIM, Yongin-si (KR); SEUNGHO KIM, Yongin-si (KR); TAEHYEOG JUNG, Yongin-si (KR); SEONGJIN HWANG, Yongin-si (KR)

(21) Appl. No.: 19/271,971

(22) Filed: Jul. 17, 2025

(30) Foreign Application Priority Data
Jul. 30, 2024 (KR) 10-2024-0100741

(51) Int. Cl. G06F 1/16

(52) U.S. Cl. CPC G06F 1/1656; G06F 1/1618; G06F 1/1641

(57) ABSTRACT

A window includes: a folding portion including a pattern portion which defines a plurality of grooves recessed from each a top surface and a bottom surface, and a filling part which fills the grooves; a first non-folding portion disposed at one side of the folding portion; and a second non-folding portion disposed apart from the first non-folding portion with the folding portion therebetween in a first direction, and each of the grooves has a rectangular pyramid shape or a truncated rectangular pyramid shape.

This application claims priority to Korean Patent Application No. 10-2024-0100741, filed on Jul. 30, 2024, and all the benefits accruing therefrom under 35 U.S.C. § 119, the content of which in its entirety is herein incorporated by reference.

### BACKGROUND

The present disclosure herein relates to a window and an electronic device including the same, and more particularly, to a foldable window and an electronic device including the same.

Electronic devices having various shapes are used to provide image information, and electronic devices including flexible display panels capable of being folded or bent are recently developed. Unlike a rigid electronic device, a flexible electronic device may be variously changed in shape, for example, being folded, rolled, or bent, and thus may be carried regardless of a displayed screen size.

This flexible electronic device requires a window for protecting the display panel, and the like, without disrupting a folding or bending operation, and accordingly, there is a need to develop a window in which a folding characteristic is maintained, and excellent display quality is maintained even in a folding portion.

### SUMMARY

The present disclosure provides a window having an excellent folding characteristic and improved in decrease of outer appearance quality due to non-uniformity in quantity of light.

The present disclosure also provides an electronic device which is improved in non-uniformity in quantity of light and improved in moire phenomenon generated due to an arrangement of emission areas and overlapping of folding patterns of a window to exhibit excellent display quality.

An embodiment of the invention provides a window including a folding portion including a pattern portion, which defines a plurality of grooves recessed from each of a top surface and a bottom surface of the window, and a filling part which fills the grooves, a first non-folding portion disposed at one side of the folding portion, and a second non-folding portion disposed apart from the first non-folding portion with the folding portion therebetween in a first direction, each of the grooves having a quadrangular rectangular pyramid shape or a truncated rectangular pyramid shape.

In an embodiment, on the top surface or the bottom surface, a shape of each of the grooves may be rectangular in a plan view.

In an embodiment, the grooves may include an upper groove recessed from the top surface, and a lower groove recessed from the bottom surface, and the upper groove and the lower groove may have the same three-dimensional shape.

In an embodiment, an upper portion of the upper groove, which has a rectangular shape, may be defined in the top surface, and a lower portion of the upper groove may be disposed adjacent to the bottom surface. A lower portion of the lower groove, which has a rectangular shape, may be defined in the bottom surface, and an upper portion of the lower groove may be disposed adjacent to the top surface. The lower portion of the upper groove and the upper portion of the lower groove which are adjacent to each other may not overlap each other in the plan view.

In an embodiment, the pattern portion may include a plurality of pattern lines which define the grooves in the top surface or the bottom surface, and an oblique surface extending from the top surface to the bottom surface so as to define sides the grooves.

In an embodiment, on a cross-section perpendicular to the top surface or the bottom surface, the pattern portion may have a zigzag pattern proceeding by repeated turns between the top surface and the bottom surface.

In an embodiment, on a cross-section perpendicular to the top surface or the bottom surface, the oblique surface may have a tilt angle of about 40° to about 55° with respect to the top surface or the bottom surface.

In an embodiment, on a cross-section perpendicular to the top surface or the bottom surface, the pattern portion may have a thickness of about 30 micrometers (μm) to about 40 μm.

In an embodiment, on a cross-section perpendicular to the top surface or the bottom surface, a deviation in thickness of the pattern portion in a direction perpendicular to the top surface or the bottom surface may be about 15 μm or less.

In an embodiment, each of the first non-folding portion and the second non-folding portion may have a thickness of about 150 μm to about 400 μm.

In an embodiment, a width of the folding portion in the first direction may be about 4% to about 25% of a total width of the window in the first direction.

In an embodiment, the window may further include a protective layer disposed on at least one of the top surface or the bottom surface.

In an embodiment of the invention, an electronic device includes a display module including a folding display portion changed into a folded or non-folded state, and a non-folding display portion adjacent to the folding display portion, and a window disposed on the display module, and including a folding portion corresponding to the folding display portion, and a non-folding portion corresponding to the non-folding display portion. The folding portion includes a pattern portion which defines a plurality of grooves recessed from each a top surface and a bottom surface, and a filling part which fill the grooves, and each of the grooves has a rectangular pyramid shape or a truncated rectangular pyramid shape.

In an embodiment, the display module may include a plurality of emission areas spaced apart from each other in a plan view, and each of the grooves may have a rectangular shape which surrounds at least one of the emission areas on the top surface or the bottom surface in the plan view.

In an embodiment, the pattern portion may include a plurality of pattern lines which define the grooves in the top surface or the bottom surface, and an oblique surface extending from the top surface to the bottom surface so as to define sides the grooves, and, on a cross-section perpendicular to the top surface or the bottom surface, the pattern portion may have a zigzag pattern proceeding by repeated turns between the top surface and the bottom surface.

In an embodiment, the grooves may include an upper groove recessed from the top surface, and a lower groove recessed from the bottom surface, and the upper groove and the bottom surface may have the same three-dimensional shape.

In an embodiment, a lower portion of the upper groove may be adjacent to the bottom surface, and an upper portion of the lower groove may be adjacent to the top surface. The lower portion of the upper groove and the upper portion of the lower groove may not overlap each other in the plan view.

In an embodiment, the pattern portion which defines the upper groove may include a plurality of first upper pattern lines extending in a first diagonal direction on the top surface, and a plurality of second upper pattern lines extending in a second diagonal direction crossing the first diagonal direction on the top surface, and the pattern portion which defines the lower groove may include a plurality of first lower pattern lines extending in the first diagonal direction on the bottom surface, and a plurality of second lower pattern lines extending in the second diagonal direction on the bottom surface.

In an embodiment, the first upper pattern lines may be arranged to be spaced apart from each other in the second diagonal direction, and the first lower pattern lines may be arranged to be spaced apart from each other in the second diagonal direction and alternately arranged with the first upper pattern lines in the plan view.

In an embodiment, a first rectangular pattern, which is defined in the top surface by two of the first upper pattern lines neighboring each other in the second diagonal direction and two of the second upper pattern lines neighboring each other in the first diagonal direction, may at least partially overlap a second rectangular pattern, which is defined on the bottom surface by two of the first lower pattern lines neighboring each other in the second diagonal direction and two of the second lower pattern lines neighboring each other in the first diagonal direction, each other.

### BRIEF DESCRIPTION OF THE FIGURES

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1A is a perspective view illustrating a spread state of an electronic device according to an embodiment;

FIG. 1B is a perspective view illustrating an in-folding operation of the electronic device according to an embodiment illustrated in FIG. 1A;

FIG. 1C is a perspective view illustrating an out-folding operation of the electronic device according to an embodiment illustrated in FIG. 1A;

FIG. 2A is a perspective view illustrating a spread state of an electronic device according to an embodiment;

FIG. 2B is a perspective view illustrating an in-folding operation of the electronic device according to an embodiment illustrated in FIG. 2A;

FIG. 2C is a perspective view illustrating an out-folding operation of the electronic device according to an embodiment illustrated in FIG. 2A;

FIG. 3A is a perspective view of an electronic device according to an embodiment;

FIGS. 3B and 3C are each a perspective view of a multi-folded state of the electronic device illustrated in FIG. 3A;

FIG. 4 is an exploded perspective view of an electronic device according to an embodiment;

FIG. 5 is a cross-sectional view of an electronic device according to an embodiment;

FIG. 6 is a plan view of a display device according to an embodiment;

FIG. 7 is a cross-sectional view of a display device according to an embodiment;

FIG. 8 is a cross-sectional view of a window according to an embodiment;

FIG. 9A is a plan view of a window according to an embodiment;

FIG. 9B is a plan view of a window according to an embodiment;

FIG. 10A is a plan view of a portion of a window according to an embodiment;

FIG. 10B is a perspective view illustrative of an arrangement of a pattern portion of a portion of a window according to an embodiment;

FIG. 11 is a cross-sectional view of a portion of a window according to an embodiment;

FIG. 12 is a perspective view of a filling part according to an embodiment;

FIG. 13A is a cross-sectional view of a portion of a window according to an embodiment;

FIG. 13B is a perspective view of a filling part according to an embodiment;

FIG. 14 is a cross-sectional view of a window according to an embodiment;

FIG. 15 is a view illustrative of light transmittance characteristics of a window according to an embodiment;

FIG. 16A is a plan view of a typical window;

FIG. 16B is a view illustrative of light transmittance characteristics of a typical window;

FIG. 17 is a plan view of some components of an electronic device according to an embodiment;

FIG. 18 is a plan view of some components of an electronic device according to an embodiment; and

FIG. 19 is a plan view of some components of an electronic device according to an embodiment.

### DETAILED DESCRIPTION

The present invention may be modified in various forms, and particular embodiments thereof will be illustrated in the drawings and described herein in detail.

The invention should not be construed as limited to the embodiments set forth herein. Rather, these embodiments are provided so that this disclosure will be thorough and complete, and will fully convey the scope of the invention to those skilled in the art.

In the present disclosure, it will be understood that when an element (or region, layer, section, etc.) is referred to as being “on”, “connected to” or “coupled to” another element, it can be disposed directly on, connected or coupled to the other element or a third element may be disposed between the elements.

Like reference numbers or symbols refer to like elements throughout. In addition, in the drawings, the thickness, the ratio, and the dimension of elements are exaggerated for effective description of the technical contents. The term “and/or” includes one or more combinations which may be defined by relevant elements.

It will be understood that, although the terms “first”, “second”, etc. may be used herein to describe various elements, these elements should not be limited by these terms. These terms are only used to distinguish one element from another element. For example, a first element could be termed a second element without departing from the teachings of the present invention, and similarly, a second element could be termed a first element. As used herein, the singular forms are intended to include the plural forms as well, unless the context clearly indicates otherwise.

In addition, the terms, such as “below”, “beneath”, “on” and “above”, are used for explaining the relation of elements shown in the drawings. The terms are relative concept and are explained based on the direction shown in the drawing.

It will be further understood that the terms such as “includes” or “has”, when used herein, specify the presence of stated features, numerals, steps, operations, elements, parts, or the combination thereof, but do not preclude the presence or addition of one or more other features, numerals, steps, operations, elements, parts, or the combination thereof.

As used herein, “being directly disposed” may mean that there is no additional layer, film, region, plate or the like between a part such as a layer, film, region, plate or the like and another part. For example, “being directly disposed” may mean that two layers or two members are disposed with no additional member such as an adhesive member.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a window according to an embodiment and an electronic device according to an embodiment will be described with reference to the accompanying drawings.

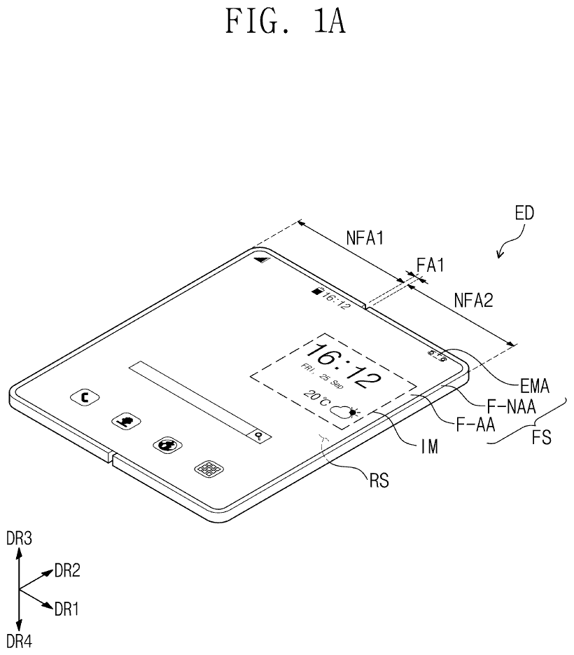

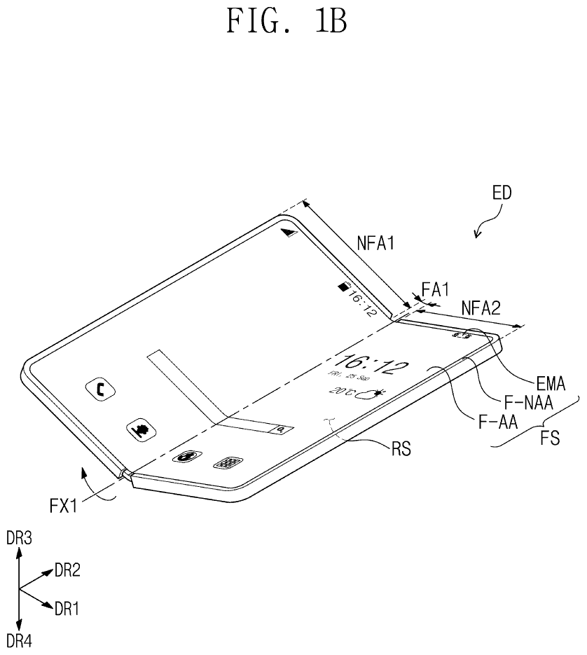

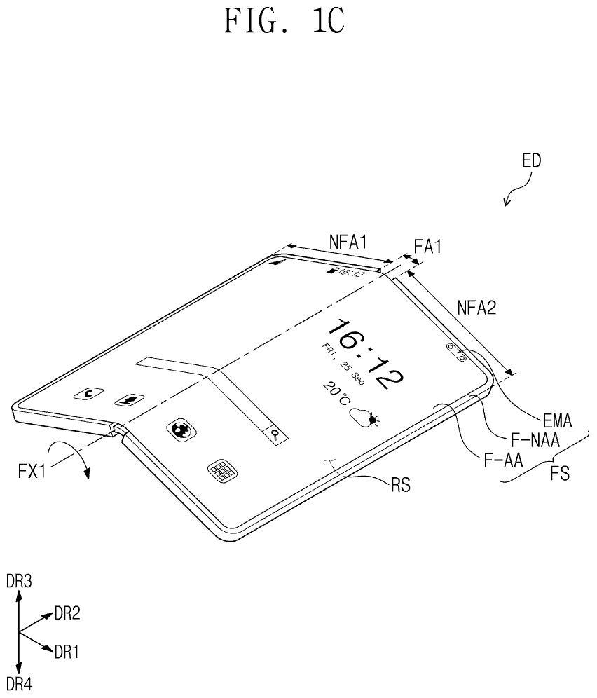

FIG. 1A is a perspective view illustrating a spread state of an electronic device according to an embodiment. FIG. 1B is a perspective view illustrating an in-folding operation of the electronic device illustrated in FIG. 1A. FIG. 1C is a perspective view illustrating an out-folding operation of the electronic device illustrated in FIG. 1A.

An electronic device ED according to an embodiment may be an apparatus that is activated in response to an electrical signal. For example, the electronic device ED may be a mobile phone, a tablet computer, a vehicle navigation unit, a game console, or a wearable device, but an embodiment is not limited thereto. In the present disclosure, FIG. 1A and the like illustrate a mobile phone as an example of the electronic device ED.

Referring to FIGS. 1A to 1C, the electronic device ED according to an embodiment may include a first display surface FS defined by a first directional axis DR1 and a second directional axis DR2 crossing the first directional axis DR1. The electronic device ED may provide an image IM for a user through the first display surface FS. The electronic device ED according to an embodiment may display the image IM in a third directional axis DR3 direction on the first display surface FS parallel to each of the first directional axis DR1 and the second directional axis DR2. In the present disclosure, a front surface (or top surface) and a rear surface (or bottom surface) of each component are defined based on a direction in which the image IM is displayed. The front surface and the rear surface may be opposite to each other in a third directional axis DR3, and a normal direction to each of the front surface and the rear surface may be parallel to the third directional axis DR3.

The electronic device ED according to an embodiment may include the first display surface FS and a second display surface RS. The first display surface FS may include an active area F-AA and a peripheral area F-NAA. The active area F-AA may include an electronic module area EMA. The second display surface RS may be defined as a surface opposite at least a portion of the first display surface FS. That is, the second display surface RS may be defined as a portion of a rear surface of the electronic device ED.

The electronic device ED according to an embodiment may detect an external input applied from the outside. The external input may include various types of inputs provided from the outside of the electronic device ED. For example, the external input may include not only a touch by part of the body, such as a user's hand, but also an external input (e.g., hovering) applied by approaching the electronic device ED or being adjacent thereto by a predetermined distance. In addition, the external input may include various types such as force, pressure, temperature, and light.

FIG. 1 and the following drawings illustrate the first directional axis DR1 to a fourth directional axis DR4, and directions indicated by the first to fourth directional axis DR1, DR2, DR3 and DR4 used herein are relative concepts and may be changed to other directions. In addition, the directions indicated by the first to fourth directional axis DR1, DR2, DR3 and DR4 may be referred to as first to fourth direction DR1, DR2, DR3 and DR4, and may be designated by like reference numbers or symbols. In the present disclosure, the first directional axis DR1 and the second directional axis DR2 perpendicularly cross each other, and the third directional axis DR3 and the fourth directional axis DR4 may each be a normal direction to a plane defined by the first directional axis DR1 and the second directional axis DR2.

A thickness direction of the electronic device ED may be a direction parallel to the third directional axis DR3 that is a normal direction to a plane defined by the first directional axis DR1 and the second directional axis DR2. The electronic device ED may provide the image IM for a user through a display surface. In the present disclosure, a front surface (or top surface) and a rear surface (or bottom surface) of each component are defined based on a direction in which the image IM is displayed. In the present disclosure, the direction in which the image IM is displayed may be defined as the third directional axis DR3 direction, and a fourth directional axis DR4 direction may be defined as a direction opposite to the third directional axis DR3 direction.

The phrase “in a plan view” used herein may be defined as being in a state when viewed in the third direction DR3. Meanwhile, directions indicated by the first to fourth directions DR1, DR2, DR3 and DR4 are relative concepts and may be changed to other directions.

The active area F-AA of the electronic device ED may be an area that is activated in response to an electrical signal. The electronic device ED according to an embodiment may display the image IM through the active area F-AA. In addition, the active area F-AA may detect various types of external inputs. The peripheral area F-NAA is adjacent to the active area F-AA. The peripheral area F-NAA may have a predetermined color. The peripheral area F-NAA may surround the active area F-AA.

Accordingly, a shape of the active area F-AA may be substantially defined by the peripheral area F-NAA. However, this is illustrated as an example, and the peripheral area F-NAA may be disposed adjacent only to one side of the active area F-AA, or may be omitted. The electronic device ED according to an embodiment of the invention may include active areas having various shapes, and is not limited to any one embodiment.

The electronic device ED may include a folding area FA1 and non-folding areas NFA1 and NFA2. In an embodiment, the non-folding areas NFA1 and NFA2 may be disposed adjacent to the folding area FA1 with the folding area FA1 therebetween. The electronic device ED according to an embodiment may include a first non-folding area NFA1 and a second non-folding area NFA2, which are disposed apart from each other with the folding area FA1 therebetween in a first directional axis DR1 direction. For example, the first non-folding area NFA1 may be disposed at one side of the folding area FA1 in the first direction DR1, and the second non-folding area NFA2 may be disposed at the other side of the folding area FA1 in the first direction DR1.

FIGS. 1A to 1C illustrate one embodiment of the electronic device ED including one folding area FA1. However, an embodiment is not limited thereto, and a plurality of folding areas may be defined in the electronic device ED. For example, the electronic device according to an embodiment may include two or more folding areas, and three or more non-folding areas disposed with each of the folding areas therebetween.

Referring to FIG. 1B, the electronic device ED according to an embodiment may be folded around a first folding axis FX1. The first folding axis FX1 is a virtual axis extending in the second directional axis DR2 direction, and the first folding axis FX1 may be parallel to a long side direction of the electronic device ED. The first folding axis FX1 may extend along the second directional axis DR2 on the first display surface FS.

The electronic device ED may be folded around the first folding axis FX1 to be changed into an in-folded state in which one area, which overlaps the first non-folding area NFA1, of the first display surface FS and the other area, which overlaps the second non-folding area NFA2, of the first display surface FS face each other.

In a state in which the electronic device ED according to an embodiment is in-folded, the second display surface RS may be visible to a user. The second display surface RS may further include an electronic module area in which an electronic module including various components is disposed, and is not limited to any one embodiment.

Referring to FIG. 1C, the electronic device ED according to an embodiment may be folded around the first folding axis FX1 to be changed into an out-folded state in which one area, which overlaps the first non-folding area NFA1, of the second display surface RS and the other area, which overlaps the second non-folding area NFA2, of the second display surface RS face each other.

However, an embodiment is not limited thereto. For example, the electronic device ED may be folded around a plurality of folding axes to be folded so that portions of each of the first display surface FS and the second display surface RS face each other, and the number of folding axes and the number of the non-folding areas accordingly are not particularly limited.

Various electronic modules may be disposed in the electronic module area EMA. For example, the electronic modules may include at least one of a camera, a speaker, a light detecting sensor, or a heat detecting sensor. The electronic module area EMA may detect an external subject received through the first or second display surface FS or RS, or provide the outside with a sound signal such as voice, through the first or second display surface FS or RS. The electronic module may include a plurality of components, and is not limited to any one embodiment.

The electronic module area EMA may be surrounded by the active area F-AA and the peripheral area F-NAA. However, an embodiment of the invention is not limited thereto. The electronic module area EMA may be disposed within the active area F-AA, and is not limited to any one embodiment.

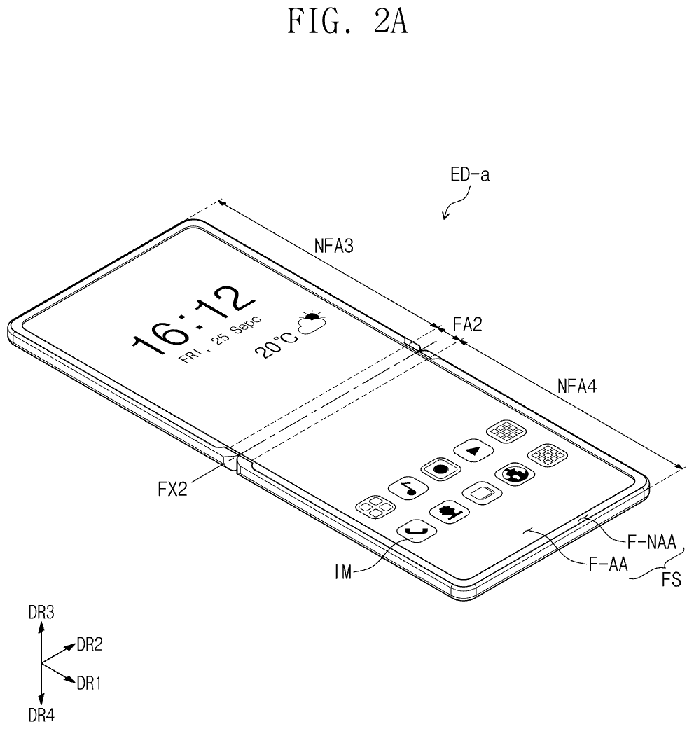

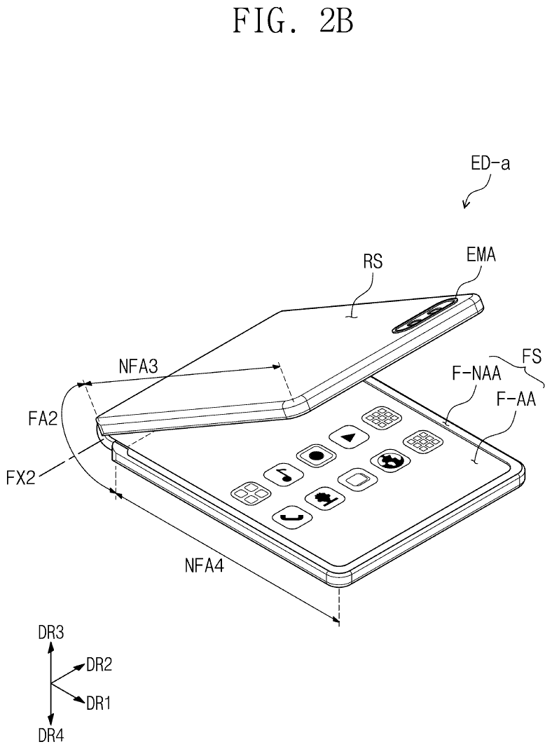

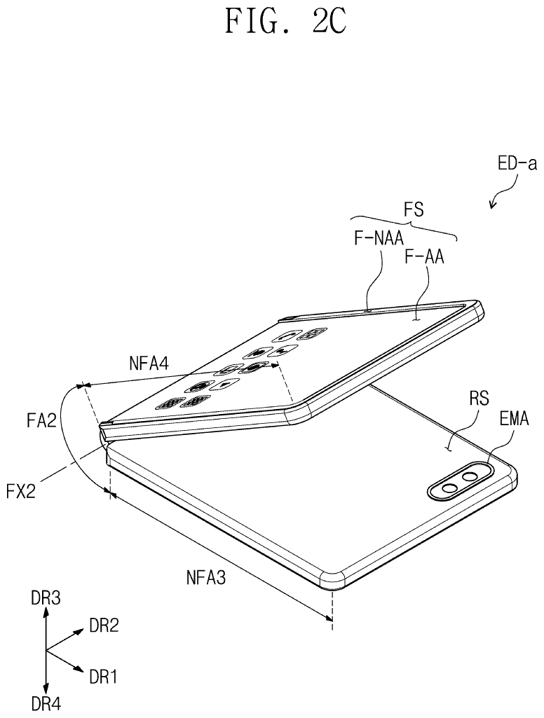

FIG. 2A is a perspective view illustrating a spread state of an electronic device according to an embodiment. FIG. 2B is a perspective view illustrating an in-folding operation of the electronic device illustrated in FIG. 2A. FIG. 2C is a perspective view illustrating an out-folding operation of the electronic device illustrated in FIG. 2A.

An electronic device ED-a according to an embodiment may be folded around a second folding axis FX2 extending in one direction parallel to the second directional axis DR2. FIG. 2B illustrates a case in which an extension direction of the second directional axis DR2 is parallel to an extension direction of a short side of the electronic device ED-a. However, an embodiment is not limited thereto.

The electronic device ED-a according to an embodiment may include at least one folding area FA2 and non-folding areas NFA3 and NFA4, each of which is adjacent to the folding area FA2. The non-folding areas NFA3 and NFA4 may be disposed apart from each other with the folding area FA2 therebetween.

The folding area FA2 has a predetermined curvature and a predetermined radius of curvature. In an embodiment, a first non-folding area NFA3 and a second non-folding area NFA4 may face each other, and the electronic device ED-a may be in-folded so that a first display surface FS is not exposed to the outside. Referring to FIG. 2C, in an embodiment, the electronic device ED-a may be out-folded so that the first display surface FS is exposed to the outside.

The electronic device ED-a according to an embodiment may include a second display surface RS, and the second display surface RS may be defined as a surface opposite at least a portion of the first display surface FS. The second display surface RS may include an electronic module area EMA in which an electronic module including various components is disposed. In addition, an image or a video may be displayed on at least a portion of the second display surface RS.

In an embodiment, in a non-folded state of the electronic device ED-a, the first display surface FS may be visible to a user, and in the in-folded state, the second display surface RS may be visible to a user.

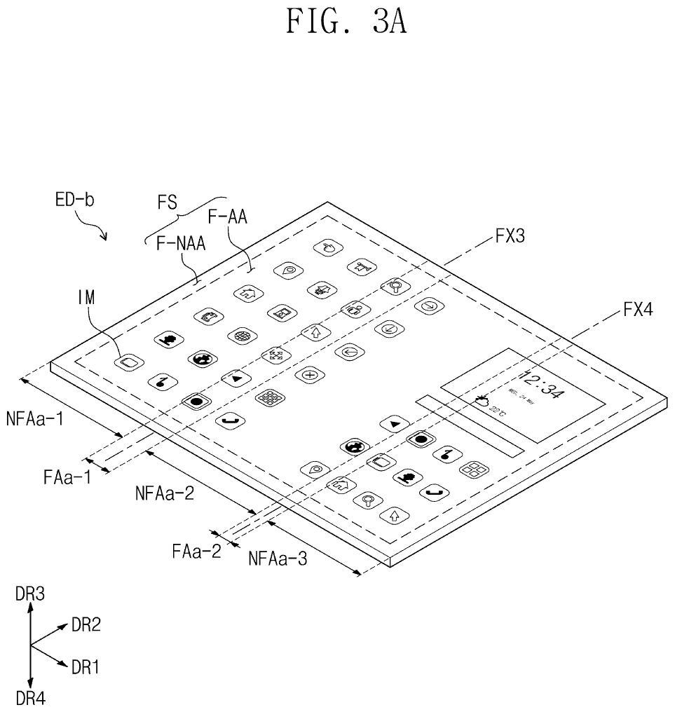

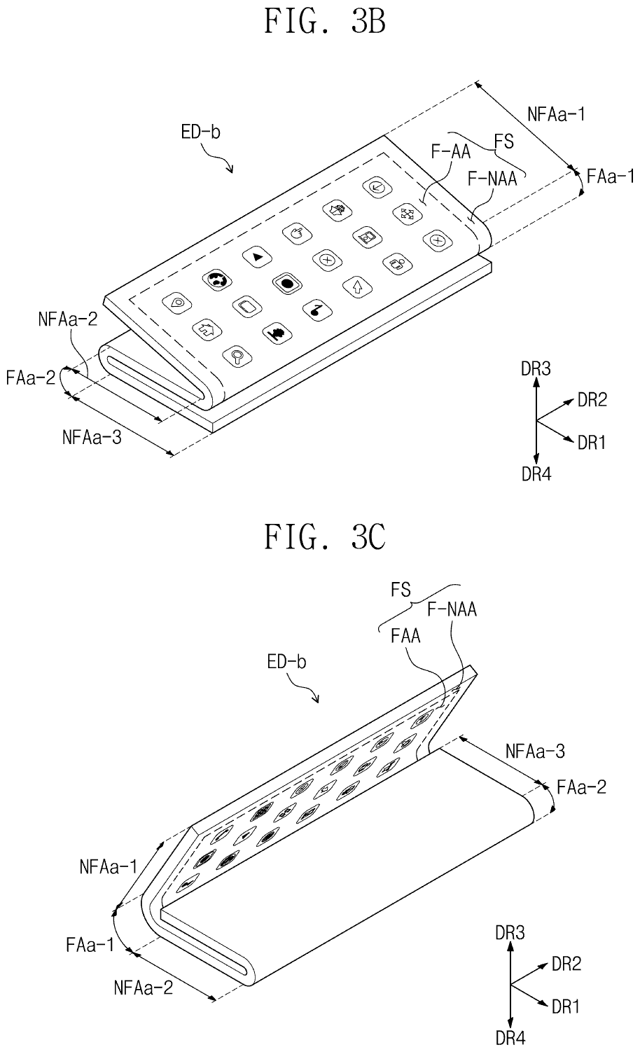

FIG. 3A is a perspective view illustrating a spread state of an electronic device ED-b according to an embodiment. FIGS. 3B and 3C are each a perspective view of a multi-folded state of the electronic device ED-b illustrated in FIG. 3A.

Referring to FIGS. 3A to 3C, the electronic device ED-b according to an embodiment may be a multi-foldable device including a plurality of folding areas. The electronic device ED-b may include a plurality of folding areas FAa-1 and FAa-2 and a plurality of non-folding areas NFAa-1, NFAa-2 and NFAa-3. The electronic device ED-b according to an embodiment may include a first folding area FAa-1, a second folding area FAa-2, a first non-folding area NFAa-1, a second non-folding area NFAa-2, and a third non-folding area NFAa-3. In the first direction DR1, the first folding area FAa-1 is disposed between the first non-folding area NFAa-1 and the second non-folding area NFAa-2, and the second folding area FAa-2 is disposed between the second non-folding area NFAa-2 and the third non-folding area NFAa-3. As an example, FIGS. 3A to 3C illustrate two folding areas FAa-1 and FAa-2 and three non-folding areas NFAa-1, NFAa-2 and NFAa-3, but the number of the folding areas FAa-1 and FAa-2 and the number of the non-folding areas NFAa-1, NFAa-2 and NFAa-3 are not limited thereto and may be increased.

Referring to FIGS. 3A and 3B, the first folding area FAa-1 may be folded around a third folding axis FX3 parallel to the second direction DR2. The first folding area FAa-1 may be out-folded so that a rear surface of the second non-folding area NFAa-2 face a rear surface of the first non-folding area NFAa-1, and a display surface of the first non-folding area NFAa-1 is exposed to the outside. The second folding area FAa-2 may be folded around a fourth folding axis FX4 parallel to the second direction DR2. The second folding area FAa-2 may be in-folded so that a display surface of the second non-folding area NFAa-2 and a display surface of the third non-folding area NFAa-3 face each other.

Referring to FIGS. 3A and 3C, the second folding area FAa-2 may be folded around the fourth folding axis FX4 parallel to the second direction DR2. The second non-folding area NFAa-2 may be in-folded so that the display surface of the second non-folding area NFAa-2 is disposed in the inside, and the display surface of the third non-folding area NFAa-3 face the display surface of the second non-folding area NFAa-2. The first folding area FAa-1 may be folded around the third folding axis FX3 parallel to the second direction DR2. The in-folding operation may be performed so that a rear surface of the third non-folding area NFAa-3 and the display surface of the first non-folding area NFAa-1 face each other.

The multi-folded state is not limited to the shapes illustrated in FIGS. 3B and 3C, and may have various folding shapes.

In an embodiment of the invention, the out-folding operation and the in-folding operation may be performed at the same time, and only one of the out-folding operation and the in-folding operation may be performed.

In an embodiment, the electronic devices ED, ED-a and ED-b may be provided to repeat an operation from a spreading operation to an in-folding or out-folding operation, or vice versa. However, an embodiment is not limited thereto. In an embodiment, the electronic devices ED, ED-a and ED-b may be provided so as to select any one among the spreading operation, the in-folding operation, and the out-folding operation. In a case in which a plurality of folding areas are included, a folding direction of at least one of the plurality of folding areas may be different from folding directions of the remaining folding areas. For example, in a case in which two folding areas are included, two non-folding areas with one folding area therebetween may be folded in the in-folding operation, and two non-folding areas with the other folding area therebetween may be folded in the out-folding operation.

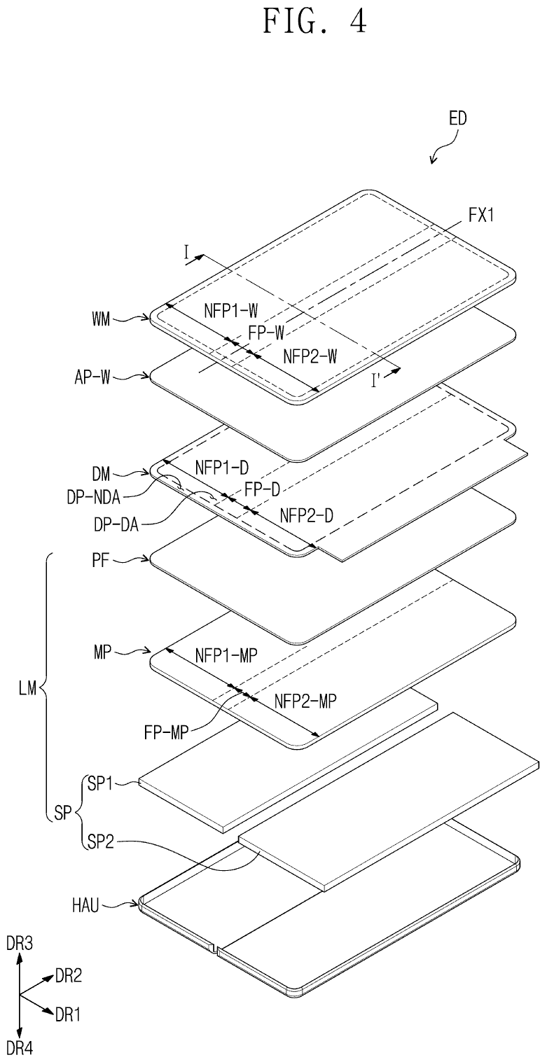

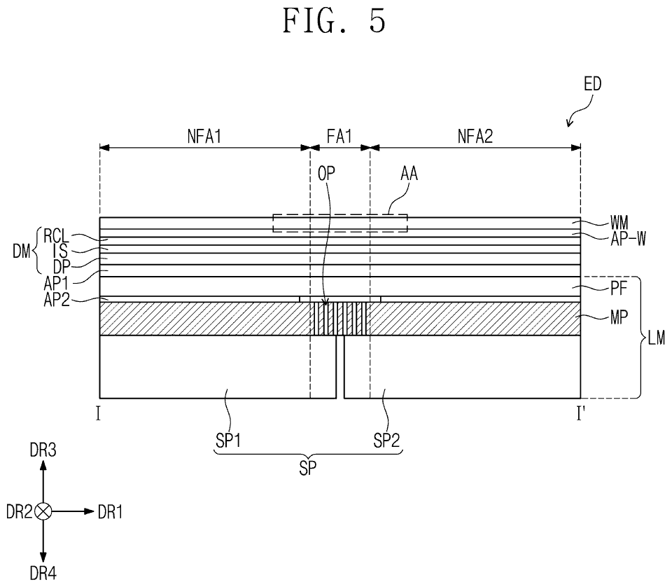

FIG. 4 is an exploded perspective view of an electronic device according to an embodiment. FIG. 5 is a cross-sectional view of an electronic device according to an embodiment. As an example, FIG. 4 illustrates an exploded perspective view of the electronic device according to an embodiment illustrated in FIG. 1A. FIG. 5 is a cross-sectional view illustrating a portion corresponding to line I-I′ in FIG. 4.

FIGS. 4 and 5 illustrate a case in which a folding axis FX1 is parallel to a long side of an electronic device ED that is the electronic device ED illustrated in FIG. 1A. However, an embodiment is not limited thereto, and contents described below with reference to the drawings may also apply to a case in which a folding axis FX2 is parallel to a short side of the electronic device as illustrated in FIG. 2A, or an electronic device which is multi-folded as illustrated in FIG. 3A.

Referring to FIGS. 4 and 5, the electronic device ED according to an embodiment may include a display module DM and a window WM disposed above the display module DM. The electronic device ED according to an embodiment may further include a lower module LM disposed below the display module DM.

The electronic device ED according to an embodiment may further include a window adhesive layer AP-W disposed between the display module DM and the window WM. Although not illustrated, a protective film (not illustrated) disposed above the window WM may be further included. The protective film may be disposed above the window WM and protect the window WM from an external environment.

The lower module LM may include a support plate MP disposed below the display module DM. The lower module LM may be referred to as a support member.

The electronic device ED may further include a housing HAU which accommodates the display module DM, the lower module LM, and the like. The housing HAU may be coupled to the window WM. Although not illustrated, the housing HAU may further include a hinge structure for easy folding or bending. In FIG. 5, the housing HAU may be omitted.

The electronic device ED according to an embodiment may include the window adhesive layer AP-W disposed between the display module DM and the window WM. The window adhesive layer AP-W may be an optically clear adhesive (OCA) film or an optically clear adhesive resin (OCR) layer. In embodiment, the window adhesive layer AP-W may be omitted.

The window WM may cover the entirety of a top surface of the display module DM. The window WM may have a shape corresponding to a shape of the display module DM. The window WM may include a glass substrate and be used as a cover window of the electronic device.

The glass substrate included in the window WM may be a tempered glass substrate. The glass substrate may be an ultra-thin tempered glass substrate.

The window WM may include a folding portion FP-W and non-folding portions NFP1-W and NFP2-W. A first non-folding portion NFP1-W and a second non-folding portion NFP2-W of the window WM may be spaced apart from each other with the folding portion FP-W therebetween in the first direction DR1. The folding portion FP-W may be a portion corresponding to a folding area FA1, and the non-folding portions NFP1-W and NFP2-W may be portions corresponding to non-folding areas NFA1 and NFA2. The window WM according to an embodiment will be described later in more detail.

The display module DM may display an image in response to an electrical signal, and transmit/receive information of an external input. The display module DM may include a display area DP-DA and a non-display area DP-NDA. The display area DP-DA may be defined as an area which emits an image provided by the display module DM.

The non-display area DP-NDA is adjacent to the display area DP-DA. For example, the non-display area DP-NDA may surround the display area DP-DA. However, this is illustrated as an example, and the non-display area DP-NDA may be defined to have various shapes, and is not limited to any one embodiment. According to an embodiment, the display area DP-DA of the display module DM may correspond to at least portion of the active area F-AA (see FIG. 1A).

In an embodiment, the display module DM includes a display panel DP. The display panel DP may be an emissive display panel, and is not particularly limited. For example, the display panel DP may be an organic light emitting display panel or an inorganic light emitting display panel. An emission layer of the organic light emitting display panel may include an organic light emitting material. An emission layer of the inorganic light emitting display panel may include a quantum dot, a quantum rod, and the like.

The display module DM may further include an input sensor IS. The input sensor IS may be directly disposed on the display panel DP. The input sensor IS may include a plurality of sensing electrodes. The input sensor IS may sense an external input using a self-capacitance method or a mutual capacitance method. The input sensor IS may sense an input by an active-type input device.

The input sensor IS may be directly formed on the display panel DP through a continuous process in manufacture of the display module DM. However, an embodiment is not limited thereto, and the input sensor IS may be manufactured as a separate panel from the display panel DP to be attached to the display panel DP through an adhesive layer (not illustrated).

The display module DM may further include an optical layer RCL. The optical layer RCL may function to reduce reflection of an external light. For example, the optical layer RCL may include a polarizing layer or a color filter layer. However, an embodiment is not limited thereto, and the optical layer RCL may include optical members for improving the display quality of the electronic device ED.

In an embodiment, the optical layer RCL may be directly disposed on the input sensor IS. In a case in which the input sensor IS is omitted in the display module DM, the optical layer RCL may be directly disposed on the display panel DP. However, an embodiment is not limited thereto, and the optical layer RCL may be disposed on the display panel DP or the input sensor IS using a separate adhesive member.

The display module DM may include a folding display portion FP-D and non-folding display portions NFP1-D and NFP2-D. The folding display portion FP-D may be a portion corresponding to the folding area FA1 (see FIG. 1A), and the non-folding display portions NFP1-D and NFP2-D may be portions corresponding to the non-folding areas NFA1 and NFA2 (see FIG. 1A).

The folding display portion FP-D may correspond to a portion folded or bent around the first folding axis FX1 (see FIGS. 1B and 1C). The display module DM may include a first non-folding display portion NFP1-D and a second non-folding display portion NFP2-D, and the first non-folding display portion NFP1-D and the second non-folding display portion NFP2-D may be spaced apart from each other with the folding display portion FP-D therebetween.

In the electronic device ED according to an embodiment, the lower module LM may include the support plate MP. In an embodiment, the lower module LM may further include at least one of a support module SP or a protective layer PF. For example, the electronic device ED according to an embodiment may include the support plate MP disposed below the display module DM, the protective layer PF disposed between the support plate MP and the display module DM, and the support module SP disposed below the support plate MP.

In an embodiment, the support plate MP may be disposed below the display module DM. The support plate MP may include a folding support portion FP-MP and non-folding support portions NFP1-MP and NFP2-MP. A first non-folding support portion NFP1-MP and a second non-folding support portion NFP2-MP of the support plate MP may be spaced apart from each other with the folding support portion FP-MP therebetween. The folding support portion FP-MP may be a portion corresponding to the folding area FA1 (see FIG. 1A), and the non-folding support portions NFP1-MP and NFP2-MP may be portions corresponding to the non-folding areas NFA1 and NFA2 (see FIG. 1A). A plurality of opening portions OP may be defined in the support plate MP. The opening portions OP may be defined to correspond to the folding area FA1.

Referring to FIGS. 4 and 5, the protective layer PF may be disposed between the display module DM and support plate MP. The protective layer PF may be a layer that is disposed below the display module DM and protects a rear surface of the display module DM. The protective layer PF may overlap the entirety of the display module DM. The protective layer PF may include a polymer material. For example, the protective layer PF may be a polyimide film or a polyethylene terephthalate film. However, this is illustrative, and the material of the protective layer PF is not limited thereto.

The electronic device ED according to an embodiment may include the support module SP. The support module SP may include support layers SP1 and SP2. The support layers SP1 and SP2 may include a first support layer SP1 and a second support layer SP2 that are spaced apart from each other in the first directional axis DR1 direction. The first support layer SP1 and the second support layer SP2 may be spaced apart from each other in a portion corresponding to the first folding axis FX1 (see FIGS. 1B and 1C). The support layers SP1 and SP2 may be spaced apart from each other in the folding area FA1 and provided as the first support layer SP1 and the second support layer SP2, thereby improving the folding or bending characteristic of the electronic device ED. Although not illustrated, the support layers SP1 and SP2 may further include components such as a cushion layer (not illustrated) and a lower support plate (not illustrated) which are stacked in the thickness direction. In the electronic device ED according to an embodiment, a combination of the components included in the lower module LM may be changed according to the size or shape of the electronic device ED, or the operation characteristics of the electronic device ED.

The electronic device ED according to an embodiment may further include one or more adhesive layers AP1 and AP2. For example, a first adhesive layer AP1 may be disposed between the display module DM and the protective layer PF, and a second adhesive layer AP2 may be disposed between the protective layer PF and the support plate MP.

The one or more adhesive layers AP1 and AP2 may each be an optically clear adhesive (OCA) film or an optically clear adhesive resin (OCR) layer. However, an embodiment is not limited thereto, and the one or more adhesive layers AP1 and AP2 may each be an adhesive layer having a low transmittance which is about 80% or less.

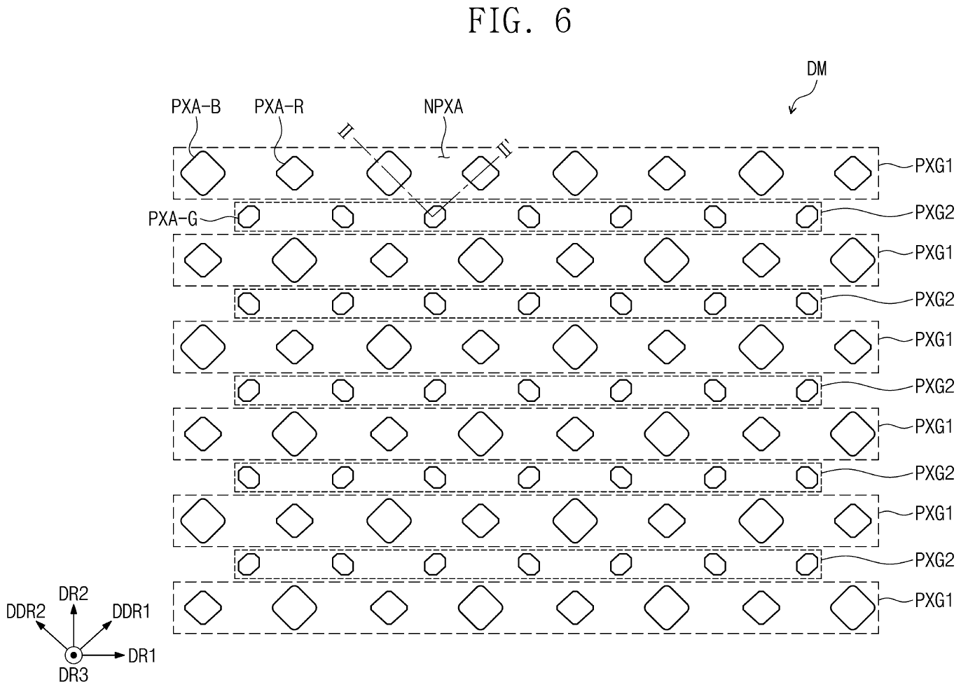

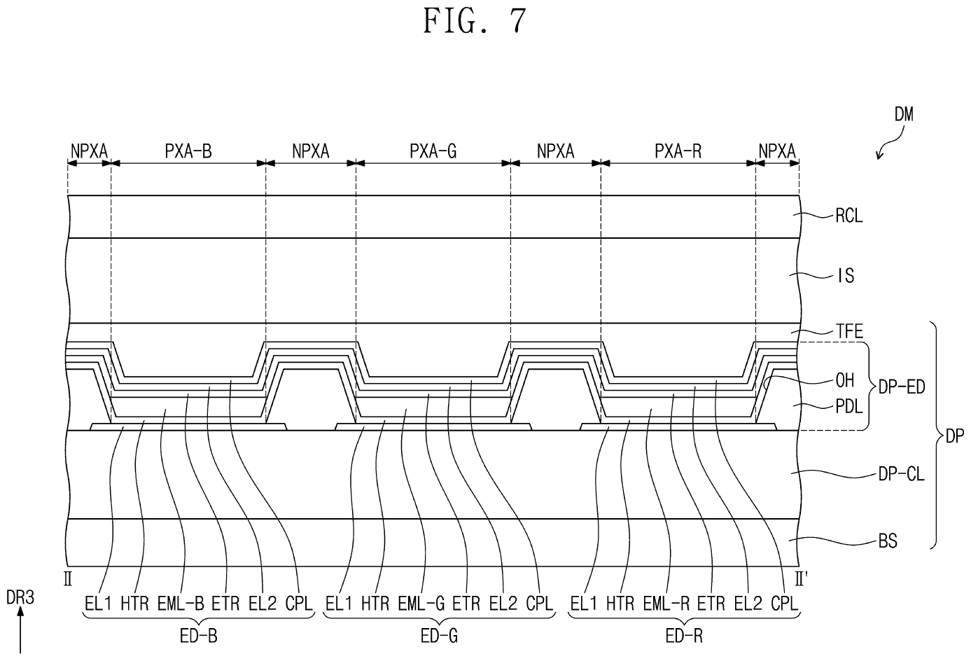

FIG. 6 is a plan view of a display module according to an embodiment. FIG. 7 is a cross-sectional view illustrating a portion corresponding to line II-II′ in FIG. 6. FIG. 7 may be a plan view of a display module according to an embodiment.

Referring to FIGS. 6 and 7, a display module DM may include a plurality of emission areas PXA-B, PXA-G and PXA-R which are repeatedly disposed in the entirety of the display area DP-DA (see FIG. 4). The display module DM according to an embodiment may include first to third emission areas PXA-B, PXA-G and PXA-R which are distinguished from each other. In addition, the display module DM may include a peripheral area NPXA disposed around the first to third emission areas PXA-B, PXA-G and PXA-R. The peripheral area NPXA sets a boundary between the first to third emission areas PXA-B, PXA-G and PXA-R. The peripheral area NPXA may surround the first to third emission areas PXA-B, PXA-G and PXA-R. A structure, for example, a pixel defining film PDL, which prevents color mixture between the first to third emission areas PXA-B, PXA-G and PXA-R, may be disposed in the peripheral area NPXA.

The pixel defining film PDL may define the emission areas PXA-B, PXA-G and PXA-R. The emission areas PXA-B, PXA-G and PXA-R and the peripheral area NPXA may be divided by the pixel defining film PDL.

A display panel DP according to an embodiment may include a plurality of light emitting elements ED-B, ED-G and ED-R which emit light in different wavelength regions. The plurality of light emitting elements ED-B, ED-G and ED-R may emit light of different colors. For example, the display panel DP may include a first light emitting element ED-B which emits blue light, a second light emitting element ED-G which emits green light, and a third light emitting element ED-R which emits red light. However, an embodiment is not limited thereto. The first to third light emitting elements ED-B, ED-G and ED-R may emit light in the same wavelength region, or at least one thereof may emit light in a different wavelength region.

Each of the emission areas PXA-B, PXA-G and PXA-R may be an area from which light generated from each of the light emitting elements ED-B, ED-G and ED-R is emitted. As an example, FIGS. 6 and 7 illustrate the first to third emission areas PXA-B, PXA-G and PXA-R which emit the blue light, the green light, and the red light, respectively. For example, the display module DM according to an embodiment may include a first emission area PXA-B which emits the blue light, a second emission area PXA-G which emits the green light, and a third emission area PXA-R which emits the red light, the first to third emission areas being distinguished from each other.

In the display module DM according to an embodiment illustrated in FIGS. 6 and 7, the emission areas PXA-B, PXA-G and PXA-R may have different surface areas according to the colors of the light emitted from emission layers EML-B, EML-G and EML-R of the light emitting elements ED-B, ED-G and ED-R. As an example, FIG. 6 illustrates the first to third emission areas PXA-B, PXA-G and PXA-R having the same shape in a plan view and having different surface areas in a plan view, but an embodiment is not limited thereto.

The first emission area PXA-B corresponding to the first light emitting element ED-B which emits the blue light may have the largest surface area, and the second emission area PXA-G corresponding to the second light emitting element ED-G which emits the green light may have the smallest surface area. However, an embodiment is not limited thereto, and the first to third emission areas PXA-B, PXA-G and PXA-R may emit light of colors other than the blue light, the green light, and the red light. Alternatively, the first to third emission areas PXA-B, PXA-G and PXA-R may have the same surface area, or the emission areas PXA-B, PXA-G and PXA-R may be provided in a different surface area ratio from that illustrated in FIG. 6. The surface areas of the first to third emission areas PXA-B, PXA-G and PXA-R may be set according to the colors of the emitted light. Here, the surface area may indicate a surface area in a plan view.

The first emission area PXA-B and the third emission area PXA-R may be alternately disposed along the first direction DR1 to constitute a first group PXG1. The second emission areas PXA-G may be arranged along the first direction DR1 to constitute a second group PXG2. The first group PXG1 may be disposed apart from the second group PXG2 in the second directional axis DR2 direction. Each of the first group PXG1 and the second group PXG2 may be provided in plurality. The first groups PXG1 and the second groups PXG2 may be arranged to alternate with each other along the second direction DR2.

One third emission area PXA-R may be disposed apart from one second emission area PXA-G in a first diagonal direction DDR1. One first emission area PXA-B may be disposed apart from one second emission area PXA-G in a second diagonal direction DDR2. The first diagonal direction DDR1 may be a direction between the first direction DR1 and the second direction DR2. The second diagonal direction DDR2 may be a direction crossing the first diagonal direction DDR1 and inclined with respect to the second direction DR2.

An arrangement structure of the emission areas PXA-B, PXA-G and PXA-R is not limited to the arrangement structure illustrated in FIG. 6. For example, in the emission areas PXA-B, PXA-G and PXA-R, the first emission area PXA-B, the second emission area PXA-G, and the third emission area PXA-R may be arranged in sequence to alternate with each other along the first direction DR1. The shapes of the emission areas PXA-B, PXA-G and PXA-R in a plan view are not limited to the illustrated shapes, and may be defined as shapes different from the illustrated shapes.

Referring to FIG. 7, the display module DM may include a display panel DP, an input sensor IS, and an optical layer RCL which are stacked in the third directional axis DR3 direction. The display panel DP may include a base substrate BS, and a circuit layer DP-CL and a display element layer DP-ED which are provided on the base substrate BS. The display element layer DP-ED may include light emitting elements ED-B, ED-G and ED-R disposed between pixel defining films PDL or on the pixel defining films PDL, and an encapsulation layer TFE disposed on the light emitting elements ED-B, ED-G and ED-R.

The base substrate BS may be a member that provides a base surface on which the display element layer DP-ED is disposed. The base substrate BS may be a glass substrate, a metal substrate, a plastic substrate, or the like. However, an embodiment is not limited thereto, and the base substrate BS may be an inorganic layer, an organic layer, or a composite material layer.

In an embodiment, the circuit layer DP-CL may be disposed on the base substrate BS, and the circuit layer DP-CL may include a plurality of transistors (not illustrated). The transistors (not illustrated) may each include a control electrode, an input electrode, and an output electrode. For example, the circuit layer DP-CL may include a switching transistor and a driving transistor each for driving the light emitting elements ED-B, ED-G and ED-R of the display element layer DP-ED.

The display element layer DP-ED may be disposed on the circuit layer DP-CL. The display element layer DP-ED may include the pixel defining films PDL, and first to third light emitting elements ED-B, ED-G and ED-R divided by the pixel defining films PDL. The light emitting elements ED-B, ED-G and ED-R of the display element layer DP-ED may be electrically connected to driving elements of the circuit layer DP-CL, and thus may generate light in response to signals provided by the driving elements and display an image.

The encapsulation layer TFE may be disposed on the display element layer DP-ED. The encapsulation layer TFE may protect the display element layer DP-ED from moisture, oxygen, and foreign matter such as dust particles. The encapsulation layer TFE may seal the light emitting elements ED-B, ED-G and ED-R of the display element layer DP-ED. The encapsulation layer TFE may include at least one thin film for improving optical efficiency of the display element layer DP-ED, or protecting the display element layer DP-ED. The encapsulation layer TFE may include at least one inorganic layer. The encapsulation layer TFE may include a structure in which an inorganic layer, an organic layer, and an inorganic layer are stacked in sequence.

The pixel defining films PDL may each be made of polymer resin. For example, the pixel defining film PDL may include polyacrylate-based resin or polyimide-based resin. The pixel defining film PDL may further include an inorganic material in addition to polymer resin. The pixel defining film PDL may include a light absorbing material, or may include a black pigment or a black dye. The pixel defining film PDL including the black pigment or the black dye may achieve a black pixel defining film. When forming the pixel defining film PDL, a carbon black or the like may be used as the black pigment or the black dye, but an embodiment is not limited thereto.

The pixel defining film PDL may be made of an inorganic material. For example, the pixel defining film PDL may be made of an inorganic material such as silicon nitride (SiNₓ), silicon oxide (SiOₓ), or silicon oxynitride (SiOₓN_{y}).

A pixel opening portion OH may be defined in the pixel defining film PDL. A portion of a first electrode EL1 may be exposed in the pixel opening portion OH. A portion corresponding to the first electrode EL1 exposed in the pixel opening portion OH may be defined as each of emission areas PXA-B, PXA-G and PXA-R. However, an embodiment is not limited thereto.

The pixel defining film PDL may divide the first to third light emitting elements ED-B, ED-G and ED-R. The emission layers EML-B, EML-G and EML-R of the first to third light emitting elements ED-B, ED-G and ED-R may be each disposed in the pixel opening portion OH defined in the pixel defining film PDL, and be divided.

Each of the first to third light emitting elements ED-B, ED-G and ED-R may include the first electrode EL1, a second electrode EL2 facing the first electrode EL1, the emission layer EML-B, EML-G or EML-R disposed between the first electrode EL1 and the second electrode EL2, and a functional layer disposed between the first electrode EL1 and the second electrode EL2. The functional layer may be disposed at at least one of a position between the first electrode EL1 and the emission layer EML-B, EML-G or EML-R or a position between the emission layer EML-B, EML-G or EML-R and the second electrode EL2. In an embodiment, each of the first to third light emitting elements ED-B, ED-G and ED-R may include the first electrode EL1, a hole transport region HTR, the emission layer EML-B, EML-G or EML-R, an electron transport region ETR, the second electrode EL2, and a capping layer CPL, which are stacked in sequence in the third directional axis DR3 direction.

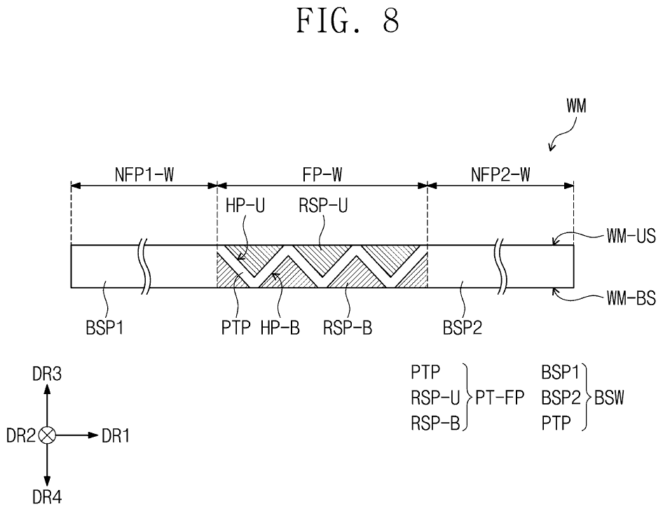

FIG. 8 is a cross-sectional view illustrating a window according to an embodiment. A window WM according to an embodiment may include a folding portion FP-W and non-folding portions NFP1-W and NFP2-W.

The folding portion FP-W may be a portion corresponding to the folding area FA1 (see FIG. 1A) of the electronic device ED (see FIG. 1A). A first non-folding portion NFP1-W may correspond to the first non-folding area NFA1 of the electronic device ED (see FIG. 1A), and a second non-folding portion NFP2-W may correspond to the second non-folding area NFA2 of the electronic device ED (see FIG. 1A).

The folding portion FP-W may correspond to a portion that may be folded or bent around a virtual folding axis to be changed in shape. The folding portion FP-W may be changed into a folded or non-folded state.

The folding portion FP-W may include a folding pattern PT-FP. The folding pattern PT-FP may include a pattern portion PTP and filling parts RSP-U and RSP-B. The folding pattern PT-FP may be referred to as a slimming pattern.

In the window WM according to an embodiment, the folding portion FP-W may include a plurality of grooves HP-U and HP-B that are defined to be concave by being recessed from a top surface WM-US and a bottom surface WM-BS of the window WM, respectively. The filling parts RSP-U and RSP-B may be filled and disposed in the grooves HP-U and HP-B, respectively. The grooves HP-U and HP-B may be defined by the pattern portion PTP. A three-dimensional shape of each of the grooves HP-U and HP-B may be a rectangular pyramid shape or a truncated rectangular pyramid shape. Accordingly, each of the filling parts RSP-U and RSP-B disposed in the grooves HP-U and HP-B may have a rectangular pyramid shape or a truncated rectangular pyramid shape.

An upper filling part RSP-U may be disposed in an upper groove HP-U recessed from the top surface WM-US of the window and defined to be concave in the fourth direction DR4 that is a bottom surface WM-BS direction of the window, and a lower filling part RSP-B may be disposed in a lower groove HP-B recessed from the bottom surface WM-BS of the window and defined to be concave in the third direction DR3 that is a top surface WM-US direction of the window.

The window WM may include a base substrate BSW, and the base substrate BSW may include the pattern portion PTP and flat portions BSP1 and BSP2. The base substrate BSW may be a tempered glass substrate. Although not illustrated, the window WM may include a compressive stress layer disposed adjacent to at least one of a top surface or a bottom surface of the base substrate BSW.

Each of a first flat portion BSP1 and a second flat portion BSP2 may include the top surface WM-US and the bottom surface WM-BS facing each other. The top surface WM-US and the bottom surface WM-BS may each be a flat surface. The pattern portion PTP constituting the folding pattern PT-FP may have a zigzag pattern shape on a cross-section perpendicular to the top surface WM-US or the bottom surface WM-BS. On a cross-section parallel to the third directional axis DR3, the pattern portion PTP of the window WM according to an embodiment may show a zigzag shape proceeding by repeated turns between the top surface WM-US and the bottom surface WM-BS of the window.

In an embodiment, the grooves HP-U and HP-B constituting the pattern portion PTP may be formed by irradiating a portion, which requires patterning, of base glass that is a base substrate, with a laser to apply a thermal damage to the base glass and then etching the thermally damaged portion through chemical etching. Here, the portion irradiated with the laser and thermally damaged may exhibit a high etching rate compared to a portion which is not irradiated with the laser. That is, in an embodiment, the folding pattern PT-FP may be formed by a laser induced deep etching (LIDE) technology that is a technology for processing a fine pattern through laser and chemical etching. Accordingly, compared to when a pattern is formed solely by a physical method, the grooves HP-U and HP-B may be easily formed, and the filling parts RSP-U and RSP-B may be provided to the grooves HP-U and HP-B to easily form the folding pattern PT-FP.

The filling parts RSP-U and RSP-B may include an organic resin. The organic resin may include at least one of acrylate-based resin, urethane-based resin, epoxy-based resin, polyester-based resin, polyether-based resin, or ABS resin. The filling parts RSP-U and RSP-B may further include inorganic particles in addition to the organic resin. To minimize a refractive index difference from the base substrate BSW, the filling parts RSP-U and RSP-B may be made of a material in which the organic resin and the inorganic particles are combined.

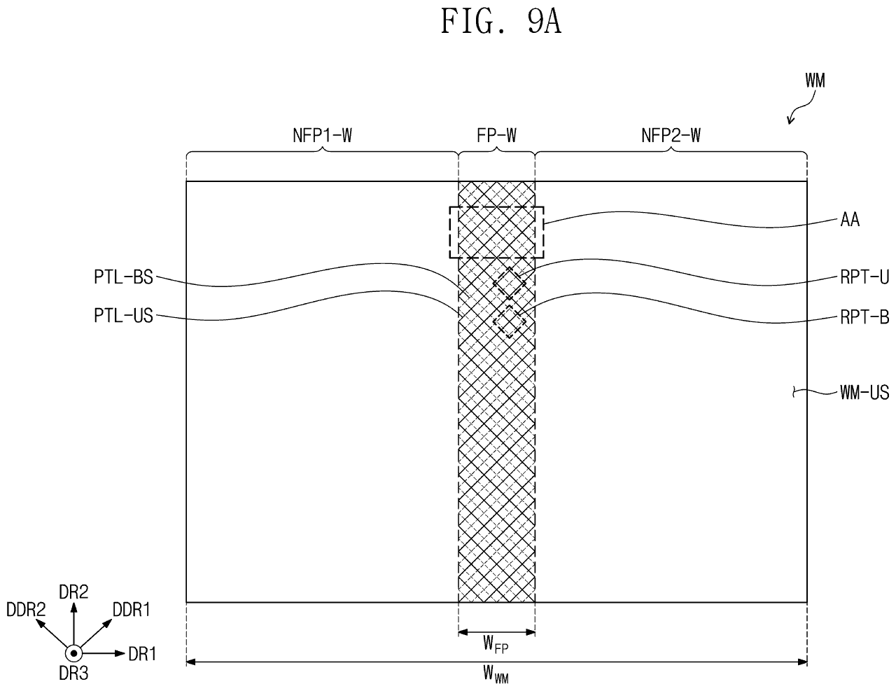

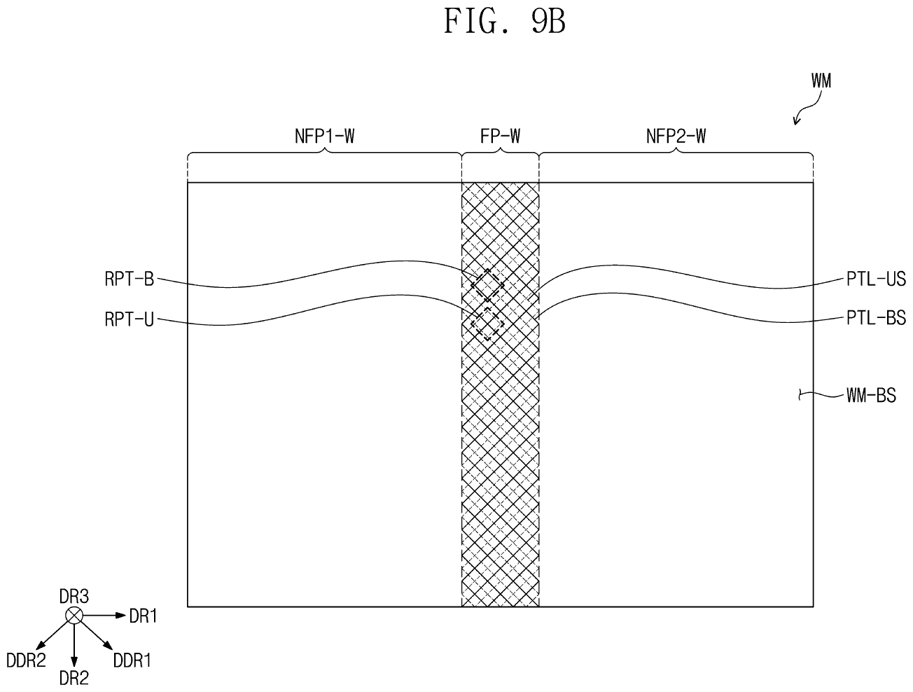

FIGS. 9A and 9B are each a plan view of a window according to an embodiment. FIG. 9A is a plan view illustrative of a top surface of a window according to an embodiment as an example. FIG. 9B is a plan view illustrative of a bottom surface of a window according to an embodiment.

Referring to FIGS. 9A and 9B, grooves HP-U and HP-B may be visible as rectangular shapes on a top surface WM-US and a bottom surface WM-BS of a window WM according to an embodiment, respectively. In the window WM according to an embodiment, the grooves HP-U and HP-B may each be defined to have a rectangular shape on the top surface WM-US or the bottom surface WM-BS.

In the window WM according to an embodiment, a width WFP of a folding portion FP-W in the first direction DR1 may be about 4% to about 25% of a total width W_{WM} of the window WM in the first direction DR1. When the width WFP of the folding portion FP-W is less than about 4% of the total width W_{WM}, the folding portion FP-W may not be sufficiently secured to decrease the folding characteristic of the window WM. When the width WFP of the folding portion FP-W is more than about 25% of the total width W_{WM}, strength and durability of the window WM may be decreased.

In FIG. 9A illustrative of the top surface WM-US of the window WM, pattern lines indicated with solid lines correspond to upper pattern lines PTL-US that define an upper pattern RPT-U which is a portion of the top surface WM-US of the window WM and has a rectangular shape. In FIG. 9A, pattern lines indicated with dotted lines correspond to lower pattern lines PTL-BS that define a lower pattern RPT-B which is disposed on the bottom surface WM-BS as a portion of the bottom surface WM-BS of the window WM and has a rectangular shape. The lower pattern lines PTL-BS are invisible from the top surface WM-US of the window WM, but illustrated to overlap the upper pattern lines PTL-US so as to show an arrangement relationship with the upper pattern lines PTL-US.

In FIG. 9B illustrative of the bottom surface WM-BS of the window WM unlike FIG. 9A, pattern lines indicated with solid lines correspond to lower pattern lines PTL-BS which define a lower pattern RPT-B which is a portion of the bottom surface WM-BS of the window WM and has a rectangular shape. In addition, pattern lines indicated with dotted lines correspond to upper pattern lines PTL-US which define an upper pattern RPT-U which is disposed on the top surface WM-US as a portion of the top surface WM-US of the window WM and has a rectangular shape. The upper pattern lines PTL-US are invisible from the bottom surface WM-BS of the window WM, but illustrated to overlap the lower pattern lines PTL-BS so as to show an arrangement relationship with lower pattern lines PTL-BS.

Referring to FIGS. 9A and 9B, in the window WM according to an embodiment, the upper pattern RPT-U and the lower pattern RPT-B which are the rectangular shapes of the grooves defined by the pattern lines PTL-US and PTL-BS, respectively, may be arranged to neighbor each other on the top surface WM-US or the bottom surface WM-BS of the window.

The plurality of upper pattern lines PTL-US, which extend in the first diagonal direction DDR1 or extend in the second diagonal direction DDR2 crossing the first diagonal direction DDR1, may be disposed on the top surface WM-US of the window. Accordingly, the upper patterns RPT-U may be arranged to neighbor each other in each of the first diagonal direction DDR1 and the second diagonal direction DDR2. Two upper patterns RPT-U adjacent to each other in the first diagonal direction DDR1 may be arranged to neighbor each other so as to share one of the upper pattern lines PTL-US extending in the second diagonal direction DDR2. In addition, two upper patterns RPT-U adjacent to each other in the second diagonal direction DDR2 may be arranged to neighbor each other so as to share one of the upper pattern lines PTL-US extending in the first diagonal direction DDR1.

Similarly, the plurality of lower pattern lines PTL-BS, which extend in the first diagonal direction DDR1 or extend in the second diagonal direction DDR2 crossing the first diagonal direction DDR1, may be disposed on the bottom surface WM-BS of the window. Accordingly, the lower patterns RPT-B may be arranged to neighbor each other in each of the first diagonal direction DDR1 and the second diagonal direction DDR2. Two lower patterns RPT-B adjacent to each other in the first diagonal direction DDR1 may be arranged to neighbor each other so as to share one of the lower pattern lines PTL-BS extending in the second diagonal direction DDR2. In addition, two lower patterns RPT-B adjacent to each other in the second diagonal direction DDR2 may be arranged to neighbor each other so as to share one of the lower pattern lines PTL-BS extending in the first diagonal direction DDR1.

The upper pattern RPT-U and the lower pattern RPT-B may at least partially overlap each other in a plan view defined by the first directional axis DR1 and the second directional axis DR2. In an embodiment, the upper pattern RPT-U and the lower pattern RPT-B may not entirely overlap each other, and only a partial area of the rectangular shape of the upper pattern RPT-U may overlap a partial area of the rectangular shape of the lower pattern RPT-B adjacent thereto. In the present disclosure, the upper pattern RPT-U may be also referred to as a “first rectangular pattern”, and the lower pattern RPT-B may be also referred to as a “second rectangular pattern”. In window WM according to an embodiment, the first rectangular pattern RPT-U and the second rectangular pattern RPT-B, which are disposed on the folding portion FP-W, may at least partially overlap each other.

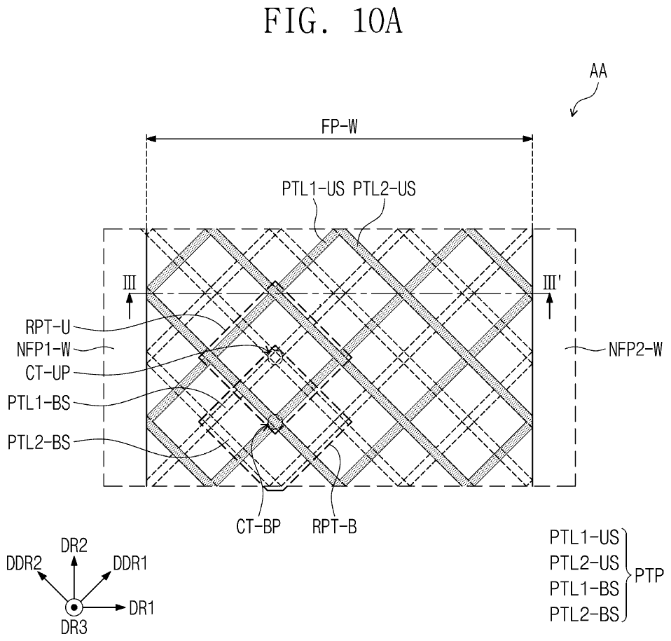

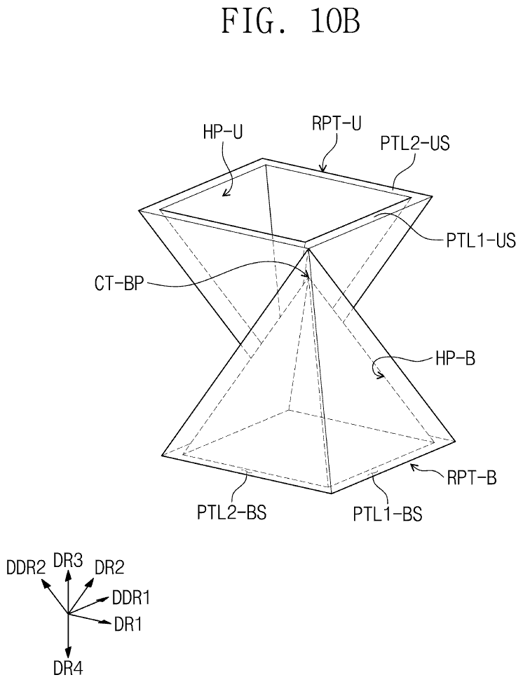

FIG. 10A is an enlarged plan view illustrating a portion of a window according to an embodiment. FIG. 10B is a perspective view illustrative of an arrangement of a pattern portion of a portion of a window according to an embodiment. FIG. 11 is a cross-sectional view of a portion of a window according to an embodiment. FIG. 10A is an enlarged plan view illustrating area AA in FIG. 9A, and FIG. 10B is a view illustrative of an arrangement shape of an upper groove and a lower groove adjacent to each other. FIG. 11 is a cross-sectional view corresponding to line III-III′ in FIG. 10A.

Referring to FIGS. 10A to 11, a pattern portion which defines an upper groove HP-U may include upper pattern lines PTL1-US, PTL2-US and PTL-US, and an oblique surface PTL-S. In addition, a pattern portion which defines a lower groove HP-B may include lower pattern lines PTL1-BS, PTL2-BS and PTL-BS, and the oblique surface PTL-S.

A pattern portion PTP which defines the upper groove HP-U may include a plurality of first upper pattern lines PTL1-US extending in the first diagonal direction DDR1 on a top surface WM-US, and a plurality of second upper pattern lines PTL2-US extending in the second diagonal direction DDR2 perpendicularly crossing the first diagonal direction DDR1. The plurality of first upper pattern lines PTL1-US may be arranged to be spaced apart from each other in the second diagonal direction DDR2, and a plurality of first lower pattern lines PTL1-BS may be arranged to be spaced apart from each other in the second diagonal direction DDR2 and cross the first upper pattern lines PTL1-US.

The pattern portion PTP which defines a lower groove HP-B may include a plurality of first lower pattern lines PTL1-BS extending in the first diagonal direction DDR1 on a bottom surface WM-BS, and a plurality of second lower pattern lines PTL2-BS extending in the second diagonal direction DDR2 perpendicularly crossing the first diagonal direction DDR1.

A first rectangular pattern RPT-U may be defined by two first upper pattern lines PTL1-US neighboring each other in the second diagonal direction DDR2 and two second upper pattern lines PTL2-US neighboring each other in the first diagonal direction DDR1. In addition, a second rectangular pattern RPT-B may be defined by two first lower pattern lines PTL1-BS neighboring each other in the second diagonal direction DDR2 and two second lower pattern lines PTL2-BS neighboring each other in the first diagonal direction DDR1.

In an embodiment, the first rectangular pattern RPT-U and the second rectangular pattern RPT-B may at least partially overlap each other.

A lower portion of the upper groove HP-U may be a portion disposed on the top surface WM-US of the window and a portion defined by the first rectangular pattern RPT-U, and an lower portion CT-UP of the upper groove HP-U may be a portion corresponding to a central portion of the upper groove HP-U. The lower portion CT-UP of the upper groove HP-U may be a portion adjacent to the bottom surface WM-BS of the window.

A lower portion of the lower groove HP-B may be a portion disposed on the bottom surface WM-BS of the window and a portion defined by the second rectangular pattern RPT-B, and an upper portion CT-BP of the lower groove HP-B may be a portion corresponding to a central portion of the lower groove HP-B. The upper portion CT-BP of the lower groove HP-B may be a portion adjacent to the top surface WM-US of the window.

In an embodiment described with reference to FIGS. 9A to 10B, the upper pattern lines PTL-U, PTL1-U and PTL2-U and the lower pattern lines PTL-B, PTL1-B and PTL2-B are illustrated as extending in the first diagonal direction DDR1 and the second diagonal direction DDR2, but an embodiment is not limited thereto. In an embodiment, the upper pattern lines PTL-U, PTL1-U and PTL2-U and the lower pattern lines PTL-B, PTL1-B and PTL2-B may extend in the first direction DR1 or the second direction DR2. In this case, the first rectangular patterns RPT-U and the second rectangular patterns RPT-B may be arranged to neighbor each other in the first direction DR1 and the second direction DR2.

Referring to FIGS. 10A and 10B, the lower portion CT-UP of the upper groove HP-U and the upper portion CT-BP of the lower groove HP-B may not overlap each other in the third direction DR3. The lower portion CT-UP of the upper groove HP-U and the upper portion CT-BP of the lower groove HP-B, which neighbor each other, may be disposed to alternate with each other.

Referring to FIG. 11, the pattern portion PTP may be patterned to have a zigzag shape on a cross-section parallel to the third direction DR3 that is the thickness direction. Filling parts RSP-U and RSP-B may be disposed in the grooves HP-U and HP-B defined by the pattern portion PTP.

Referring to FIG. 11, on a cross-section parallel to the third direction DR3, a cross-sectional shape of each of an upper filling part RSP-U filled in the upper groove HP-U and a lower filling part RSP-B filled in the lower groove HP-B may be a triangle. In an embodiment, a three-dimensional shape of each of the grooves HP-U and HP-B included in the window WM and a three-dimensional shape of each of the filling parts RSP-U and RSP-B filled in the grooves HP-U and HP-B may be a rectangular pyramid shape.

In a case in which the upper groove HP-U has a rectangular pyramid shape, a lower portion of the upper groove HP-U may correspond to a base portion that is rectangular, and an lower portion CT-UP of the upper groove HP-U may correspond to a portion including an apex at a position opposite a base of a rectangular pyramid.

In a case in which the lower groove HP-B has a rectangular pyramid shape, a lower portion of the lower groove HP-B may correspond to a base portion that is rectangular, and an upper portion CT-BP of the lower groove HP-B may correspond to a portion including an apex at a position opposite a base of a rectangular pyramid.

In an embodiment, the window WM may have a total thickness t_{WM} of about 150 μm to about 400 μm. FIG. 11 illustrates only a partial area corresponding to a folding portion of the window WM, but the total thickness t_{WM} may correspond to a thickness of each of a first non-folding portion NFP1 and a second non-folding portion NFP2. When the total thickness t_{WM} of the window WM is less than about 150 μm, durability of the window WM may be decreased, and when the total thickness t_{WM} of the window WM is more than about 400 μm, a thin profile of the electronic device may be difficult to achieve, and the folding characteristic may be decreased.

In the window WM according to an embodiment, on a cross-section perpendicular to the top surface WM-US or the bottom surface WM-BS, the oblique surfaces PTL-S which define each of the grooves HP-U and HP-B may each have a tilt angle θ_{DA} of about 40° to about 55°. The oblique surfaces PTL-S may each have the tilt angle θ_{DA} of about 40° to about 55° with respect to the top surface WM-US or the bottom surface WM-BS, thereby minimizing a deviation in length of the pattern portion PTP in the third direction DR3 through which light provided at different positions on the bottom surface WM-BS to pass through the window WM in the third direction DR3. Accordingly, a difference in quantity of the light, which is finally observed by a user after passing through the pattern portion PTP at different positions in a plan view, may be minimized. In the window WM according to an embodiment, a luminance deviation due to the difference in quantity of the transmitted light between the positions may be minimized, and a phenomenon in which unevenness is visible due to the difference in quantity of the light between the positions may be reduced.

In an embodiment, the pattern portion PTP may have a thickness of about 30 μm to about 40 μm. Thicknesses of portions constituting the pattern portion PTP which defines the grooves HP-U and HP-B may be each independently about 30 μm to about 40 μm. A thickness t_{PT-U} of the upper pattern line PTL-US corresponds to a thickness from the top surface WM-US of the window to the upper portion CT-BP of the lower groove HP-B in the third direction DR3, and a thickness t_{PT-B} of the lower pattern line PTL-BS corresponds to a thickness from the bottom surface WM-BS of the window WM to the lower portion CT-UP of the upper groove HP-U in the third direction DR3. In addition, a thickness t_{PT-S} of the oblique surface PTL-S corresponds to a thickness in a direction perpendicular to an extension direction of the oblique surface PTL-S.

In an embodiment, the thickness t_{PT-U} of the upper pattern line PTL-US, the thickness t_{PT-B} of the lower pattern line PTL-BS, and the thickness t_{PT-S} of the oblique surface PTL-S may be each independently about 30 μm to about 40 μm. In an embodiment, the thickness t_{PT-U} of the upper pattern line PTL-US, the thickness t_{PT-B} of the lower pattern line PTL-BS, and the thickness t_{PT-S} of the oblique surface PTL-S may be substantially the same. Alternatively, in an embodiment, the thickness t_{PT-U} of the upper pattern line PTL-US and the thickness t_{PT-B} of the lower pattern line PTL-BS may be the same, and the thickness t_{PT-S} of the oblique surface PTL-S may be different from each of the thickness t_{PT-U} of the upper pattern line PTL-US and the thickness t_{PT-B} of the lower pattern line PTL-BS.

A deviation in thickness of the pattern portion PTP in a direction perpendicular to the top surface WM-US or the bottom surface WM-BS of the window may be about 15 μm or less. A difference between the thickness t_{PT-U} of the upper pattern line PTL-US and a thickness t_{PT-SV} of the oblique surface PTL-S in a vertical direction (i.e., third direction DR3), and a difference between the thickness t_{PT-B} of the lower pattern line PTL-BS and the thickness t_{PT-SV} of the oblique surface PTL-S in the vertical direction may be each independently about 15 μm or less. Accordingly, the window WM according to an embodiment may minimize the deviation in length of the pattern portion PTP through which light provided at different positions to pass through the window WM passes in a plan view which is parallel to the third direction DR3 that is the thickness direction, or the fourth direction DR4 opposite thereto, and is perpendicular to the third direction DR3. In an embodiment, the different in quantity of the light, which is finally observed after being provided from above or below the window WM and passing through the pattern portion PTP at different positions in a plan view, may be minimized. Accordingly, the luminance deviation due to the difference in quantity of the transmitted light between the positions may be minimized, and the phenomenon in which unevenness is visible due to the difference in quantity of the light between the positions may be reduced.

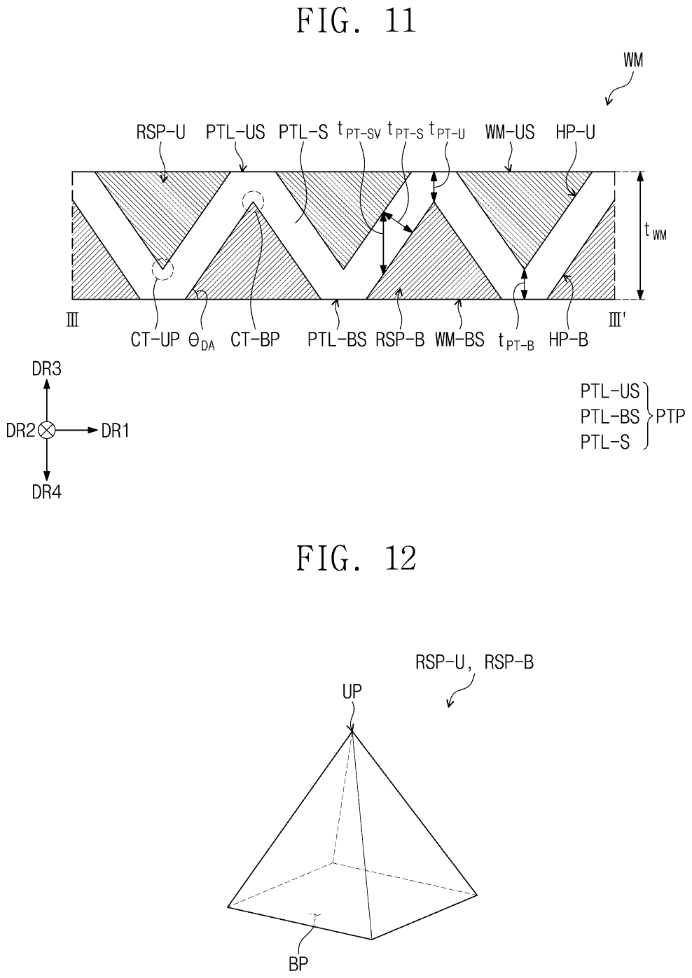

FIG. 12 is a perspective view illustrative of a shape of a filling part included in a window WM according to an embodiment. A filling part RSP-U or RSP-B in FIG. 12 may have the shape of each of the upper filling part RSP-U and the lower filling part RSP-B included in the window WM in FIG. 11. An upper portion UP of the filling part RSP-U or RSP-B having a rectangular pyramid shape illustrated in FIG. 12 may be a portion corresponding to each of an lower portion CT-UP of the upper groove HP-U and an upper portion CT-BP of the lower groove HP-B. A base BP of the filling part RSP-U or RSP-B having a rectangular pyramid shape illustrated in FIG. 12 may be a portion disposed on a top surface or a bottom surface of the window WM.

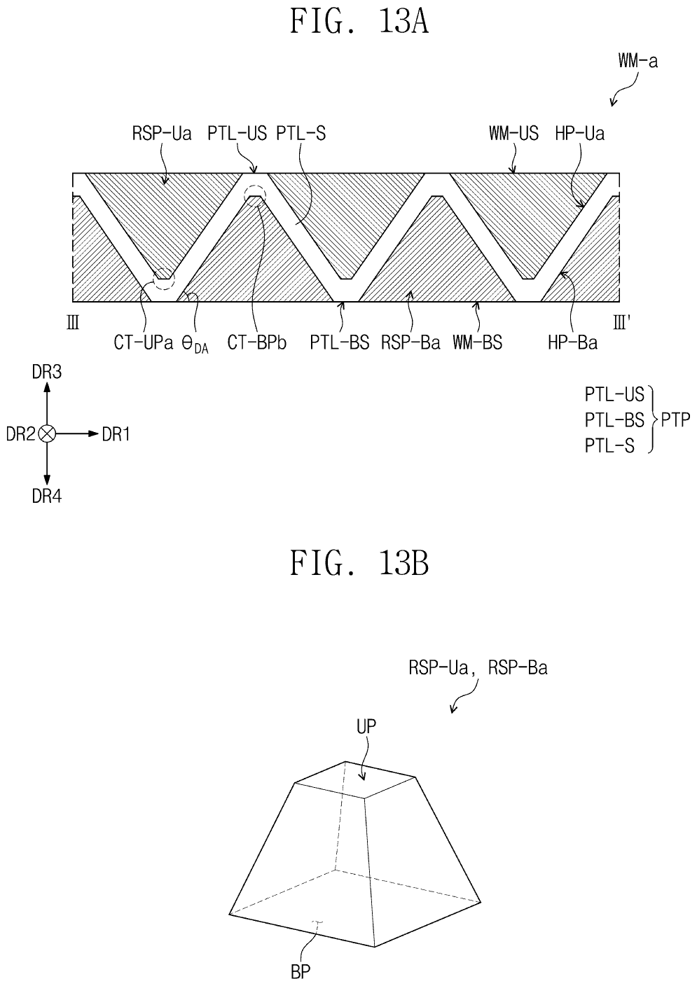

FIG. 13A is a cross-sectional view of a window according to an embodiment. A window WM-a according to an embodiment differs from the window WM according to an embodiment illustrated in FIG. 11, etc. in terms of three-dimensional shapes of a groove and a filling part which fills the groove.

In the window WM-a according to an embodiment, an upper groove HP-Ua and a lower groove HP-Ba may each have a three-dimensional shape that is a truncated rectangular pyramid shape. Each of the upper groove HP-Ua and the lower groove HP-Ba may be defined by an upper pattern line PTL-US, a lower pattern line PTL-BS, and an oblique surface PTL-S. An upper filling part RSP-Ua filed in the lower groove HP-Ba and a lower filling part RSP-Ba filed in the lower groove HP-Ba may each have a three-dimensional shape that is a truncated rectangular pyramid shape.

On a cross-section parallel to the third direction DR3, the oblique surface PTL-S constituting a pattern portion PTP of the window WM-a according to an embodiment may have a tilt angle θ_{DA} of about 40° to about 55°. The oblique surface PTL-S may have the tilt angle θ_{DA} of about 40° to about 55° with respect to a top surface WM-US or a bottom surface WM-BS, thereby minimizing a deviation in length of the pattern portion PTP in the third direction DR3 through which light provided at different positions on the bottom surface WM-BS to pass through the window WM-a in the third direction DR3.

Referring to FIG. 13A, the pattern portion PTP may be patterned to have a zigzag shape on a cross-section parallel to the third direction DR3 that is the thickness direction. The filling parts RSP-Ua and RSP-Ba may be disposed in the grooves HP-Ua and HP-Ba defined by the pattern portion PTP.

Referring to FIG. 13A, on a cross-section parallel to the third direction DR3, a cross-sectional shape of each of the upper filling part RSP-Ua filled in the upper groove HP-Ua and the lower filling part RSP-Ba filled in the lower groove HP-Ba may be a trapezoid shape. In an embodiment, a three-dimensional shape of each of the grooves HP-Ua and HP-Ba included in the window WM-a and a three-dimensional shape of each of the filling parts RSP-Ua and RSP-Ba filled in the grooves HP-Ua and HP-Ba may be truncated rectangular pyramid shapes.

FIG. 13B is a perspective view illustrative of a shape of a filling part included in a window WM-a according to an embodiment. A filling part RSP-Ua or RSP-Ba in FIG. 13B may have the shape of each of the upper filling part RSP-Ua and the lower filling part RSP-Ba included in the window in FIG. 13A. An upper portion UP of the filling part RSP-Ua or RSP-Ba having a rectangular pyramid shape illustrated in FIG. 13B may be a portion corresponding to each of an lower portion CT-UPa of the upper groove HP-Ua and an upper portion CT-BPa of the lower groove HP-Ba. A base BP of the filling part RSP-Ua or RSP-Ba having a rectangular pyramid shape illustrated in FIG. 13B may be a portion disposed on a top surface or a bottom surface of the window WM.

In a case in which the upper groove HP-Ua has a truncated rectangular pyramid shape, a lower portion of the upper groove HP-Ua may correspond to a base BP having a rectangular shape having a relatively large surface area, and the lower portion CT-UPa of the upper groove HP-Ua may correspond to the upper portion UP which is at a position opposite the base and is a rectangle having a relatively small surface area.

In a case in which the lower groove HP-Ba has a truncated rectangular pyramid shape, a lower portion of the lower groove HP-Ba may correspond to a base BP portion having a rectangular shape having a relatively large surface area, and the upper portion CT-BPa of the lower groove HP-Ba may correspond to the upper portion UP which is at a position opposite the base and is a rectangle having a relatively small surface area.

FIG. 14 is a cross-sectional view of a window according to an embodiment. A window WM-1 according to an embodiment may further include a protective layer CVL disposed on at least one of an upper side or a lower side of a base substrate BSW. Compared to the window WM according to an embodiment illustrated in FIG. 8, the window WM-1 according to an embodiment illustrated in FIG. 14 may further include the protective layer CVL disposed on a top surface WM-US. The protective layer CVL may overlap the entirety of a first flat portion BSP1, a second flat portion BSP2, and a folding pattern PT-FP.

In an embodiment, the protective layer CVL may become the uppermost layer of the window WM-1. The protective layer CVL may be provided as a coating layer including an organic material or an inorganic material for protecting the top surface of the window. The protective layer CVL may include an acrylic compound, an epoxy-based compound, a siloxane-based compound, or a urethane-based compound. For example, the protective layer CVL may further include a functional layer material such as a hard coating agent.

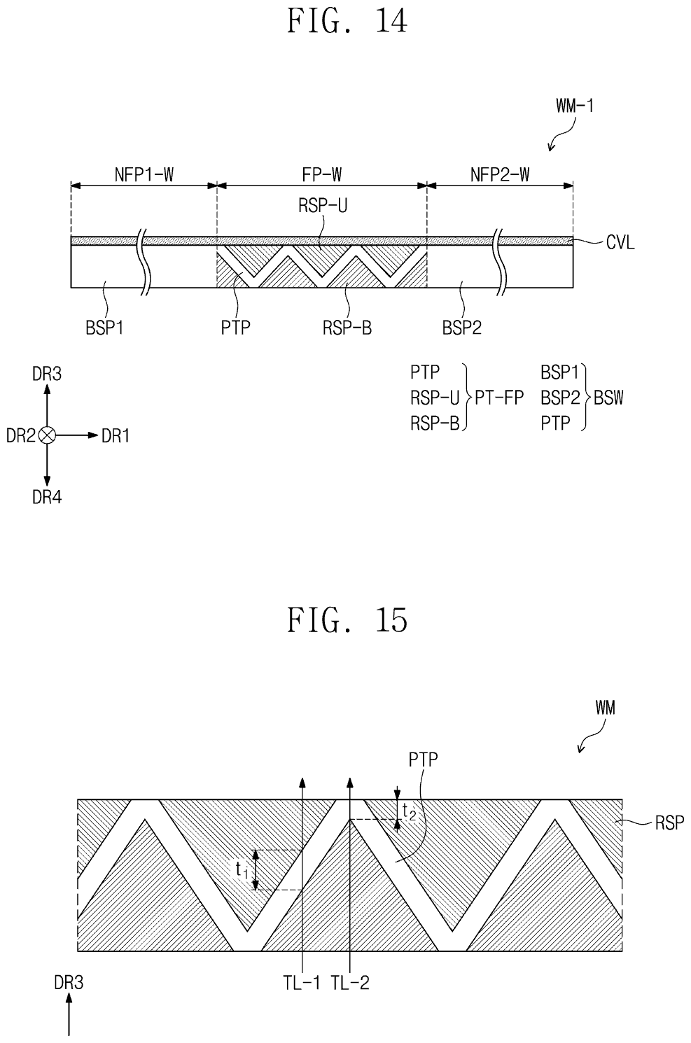

FIG. 15 illustrates a schematic view for comparing a difference in length of a pattern portion through which light passes for each position in a window according to an embodiment. In a window WM according to an embodiment, a length of a pattern portion PTP through which light TL-1 and TL-2 provided in the third direction DR3 passes may be different between positions. However, in the window WM according to an embodiment, the pattern portion PTP may be provided to have a zigzag shape on a cross-section perpendicular to the third direction DR3, and a tilt angle of the zigzag shape of the pattern portion PTP may be adjusted such that a deviation in length of the pattern portion PTP in the third direction DR3 is minimized, thereby minimizing a difference between lengths t₁ and t₂ of the pattern portion PTP through which the light TL-1 and TL-2 provided at different positions passes. Accordingly, a difference in quantity of the light, which is finally observed from above after first light TL-1 and second light TL-2 provided in the same quantity of light and provided at different positions passes through the window WM according to an embodiment, may be minimized. Thus, in the window WM according to an embodiment, shapes of the grooves defined to be concave by being recessed from the top surface and the bottom surface of the window WM, respectively, may each have a rectangular pyramid shape or a truncated rectangular pyramid shape, and the tilt angle of the oblique surface of the pattern portion which defines the grooves may be optimized, thereby minimizing the difference in quantity of the emitted light between positions in the pattern portion. That is, the window WM according to an embodiment may minimize a difference between a quantity of light emitted after passing through the oblique surface of the pattern portion and a quantity of light emitted after passing through the upper pattern line or the lower pattern line of the pattern portion, thereby reducing the luminance deviation due to the difference in quantity of the transmitted light and minimizing unevenness and the like which may be visible due to the difference in quantity of the light.

Therefore, in the window WM according to an embodiment, the entire area of the portion on which the pattern portion is provided may also exhibit uniform light transmittance, and accordingly, the electronic device including the window according to an embodiment may exhibit excellent display quality and outer appearance quality.

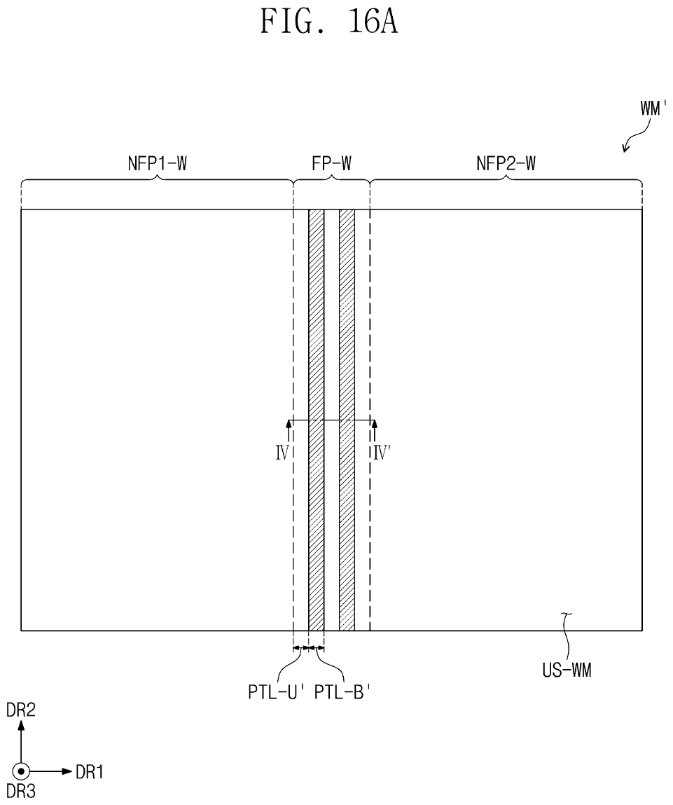

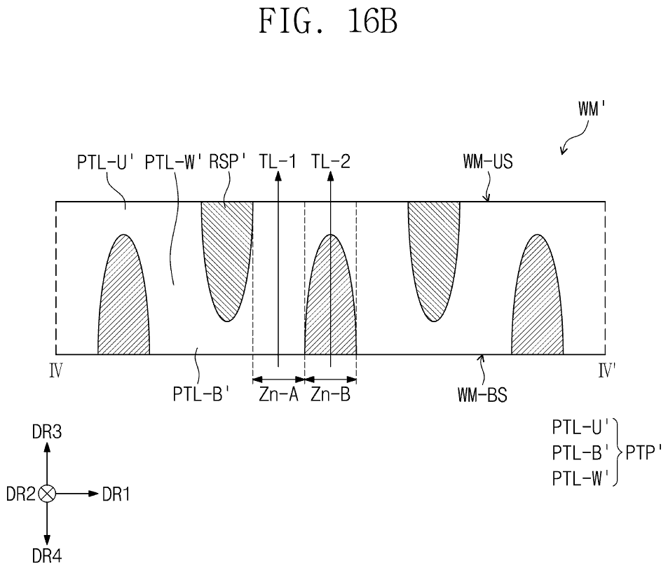

FIG. 16A is a view illustrative of a plan view of a typical window. FIG. 16B is a view illustrative of a cross-section of a portion of a typical window.

A typical window WM′ may include a folding portion FP-W, and a first non-folding portion NFP1-W and a second non-folding portion NFP2-W which are spaced apart from each other with the folding portion FP-W therebetween in the first direction DR1. The folding portion FP-W may include a slimming pattern PTP′ provide to extend in the second direction DR2 crossing the first direction DR1. The slimming pattern PTP′ may be defined to include a groove concavely recessed from a top surface or a bottom surface of the window.

The slimming pattern PTP′ may include an upper pattern PTL-U′ disposed on a top surface WM-US of the window, a lower pattern PTL-B′ disposed on a bottom surface WM-BS of the window, and a wall pattern PTL-W′ disposed between the upper pattern PTL-U′ and the lower pattern PTL-B′. A filling part RSP′ may be disposed in the groove defined by the slimming pattern PTP′.

In the typical window WM′, each of the upper pattern PTL-U′ and the lower pattern PTL-B′ which constitute the slimming pattern PTP′ has a stripe shape extending in one direction. In the typical window WM′, light TL-1 and TL-2 provided in a direction parallel to the third direction DR3 shows a significant difference between a quantity of light passing through the upper pattern PTL-U′ or the lower pattern PTL-B′ and a quantity of light passing through the wall pattern PTL-W′. The quantities of light transmitted in the second direction DR2 that is an extension direction of the stripe shape are similar. However, in the first direction DR1, a difference between a quantity of light passing through a portion that is the wall pattern PTL-W′ and a quantity of light passing through a portion that is the upper pattern PTL-U′ or the lower pattern PTL-B′ is significant, and thus a first area Zn-A and a second area Zn-B, which extend in the second direction DR2 and alternate with each other in the first direction DR1 and are different in quantity of the light, appear to be divided. Due to this difference in quantity of the light, when using the typical window WM′, the areas Zn-A and Zn-B having stripe shapes different in luminance to be visible may appear, and this may be visible as an unevenness phenomenon. In addition, when an arrangement of these areas Zn-A and Zn-B different in quantity of the transmitted light and an arrangement of emission areas in the display module overlap each other, a moire phenomenon may appear.

However, the window according to an embodiment may include the pattern portion having the zigzag pattern on a cross-section to prevent the wall pattern PTL-W′ having the significant difference in thickness like the typical window from being included in the pattern portion, thereby reducing the thickness deviation of the pattern portion in a light-transmission direction to minimize the difference in quantity of the light emitted after passing through the pattern portion.

Accordingly, when compared to the typical window, the window according to an embodiment may exhibit the characteristics in which the unevenness phenomenon due to the difference in quantity of the transmitted light is improved. In addition, in the window according to an embodiment unlike the typical window having the slimming pattern in which the grooves are aligned in one direction, the grooves may not be aligned in one direction but be uniformly arranged in the entire area of the folding portion, and the upper groove and the lower groove each having a rectangular pyramid shape or a truncated rectangular pyramid shape may be alternately arranged, thereby exhibiting the characteristics in which the moire phenomenon likely to occur due to overlapping between the emission areas of the display module and the pattern when the slimming pattern is provided in a stripe shape is improved.

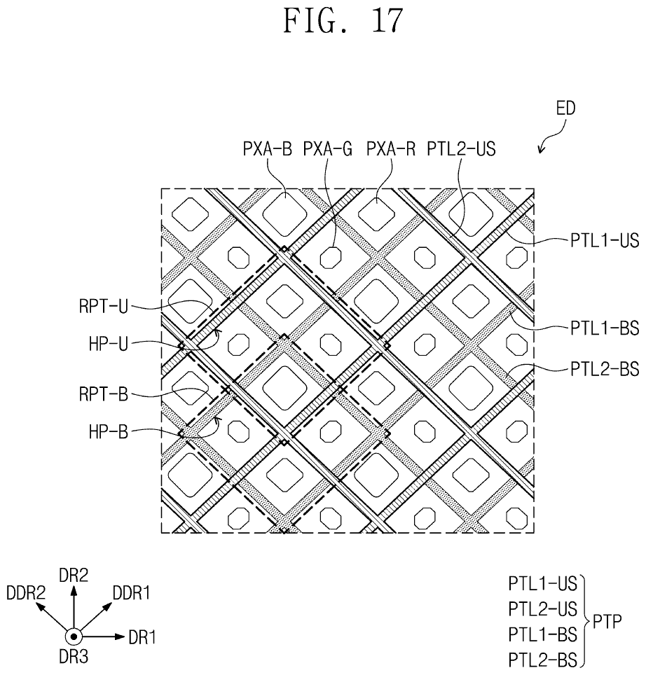

FIGS. 17 to 19 are each a schematic plan view illustrating a portion of an electronic device according to an embodiment. FIGS. 17 to 19 illustrate only an arrangement shape of emission areas and an arrangement shape of a pattern portion of a window in the electronic device. Hereinafter, the electronic devices according to an embodiment will be described with reference to FIGS. 17 to 19 by avoiding the contents in common with the contents described with reference to FIGS. 1A to 15, and mainly in terms of differences.

An arrangement shape of emission areas PXA-B, PXA-G and PXA-R in each of electronic devices ED, ED-1 and ED-2 according to an embodiment illustrated in FIGS. 17 to 19 is the same as the arrangement shape of the emission areas in the display module described with reference to FIG. 6.

In the electronic devices ED, ED-1 and ED-2 according to an embodiment, the emission areas PXA-B, PXA-G and PXA-R may be disposed apart from each other in a plan view, and an upper groove HP-U and a lower groove HP-B, which are defined by a pattern portion PTP of a window WM may each have a rectangular shape in a plan view parallel to a top surface or a bottom surface of the window. On the top surface or the bottom surface of the window, the rectangular shapes of the upper groove HP-U and the lower groove HP-B may each be disposed to surround at least one of the emission areas PXA-B, PXA-G and PXA-R.

In a plan view defined by the first direction DR1 and the second direction DR2, an upper pattern RPT-U which defines the upper groove HP-U and is disposed on the top surface of the window may have a rectangular shape which surrounds the upper groove HP-U. The upper pattern RPT-U may be defined by first upper pattern lines PTL1-US neighboring each other in the second diagonal direction DDR2 and extending in the first diagonal direction DDR1, and two second upper pattern lines PTL2-US neighboring each other in the first diagonal direction DDR1 and extending in the second diagonal direction DDR2. The upper pattern RPT-U that is a first rectangular pattern may surround a group of a plurality of emission areas that are one first emission area PXA-B, two second emission areas PXA-G, and one third emission area PXA-R.

In a plan view defined by the first direction DR1 and the second direction DR2, a lower pattern RPT-B which defines the lower groove HP-B and is disposed on the bottom surface of the window may have a rectangular shape which surrounds the lower groove HP-B. The lower pattern RPT-B may be defined by first lower pattern lines PTL1-BS neighboring each other in the second diagonal direction DDR2 and extending in the first diagonal direction DDR1, and second lower pattern lines PTL2-BS neighboring each other in the first diagonal direction DDR1 and extending in the second diagonal direction DDR2. The lower pattern RPT-B that is a second rectangular pattern may surround a group of emission areas that are one first emission area PXA-B, two second emission areas PXA-G, and one third emission area PXA-R.

The lower groove HP-B defined by the lower pattern RPT-B that is a second rectangular pattern may at least partially overlap the upper pattern RPT-U defined by the upper pattern RPT-U that is a first rectangular pattern. Accordingly, some of the emission areas surrounded by the upper pattern RPT-U may be also surrounded by the lower pattern RPT-B.

In an embodiment illustrated in FIG. 17, the first upper pattern line PTL1-US and the first lower pattern line PTL1-BS may be alternately arranged in the second diagonal direction DDR2. In addition, the second upper pattern line PTL2-US and the second lower pattern line PTL2-BS may be alternately arranged in the first diagonal direction DDR1.

Referring to FIG. 17, in an embodiment, the upper pattern RPT-U and the lower pattern RPT-B, which are disposed to neighbor in the second direction DR2 and partially overlap each other in the third direction DR3, may overlap each other so as to surround the same first emission area PXA-B or overlap each other so as to surround the same third emission area PXA-R. In an embodiment, the upper pattern RPT-U and the lower pattern RPT-B, which are disposed to neighbor in the first direction DR1 and partially overlap each other in the third direction DR3, may overlap each other so as to surround the same second emission area PXA-G.

Referring to FIG. 17, in an embodiment, each of the emission areas PXA-B, PXA-G and PXA-R may be surrounded by the first upper pattern line PTL1-US and the second upper pattern line PTL2-US crossing each other, and the first lower pattern line PTL1-BS and the second lower pattern line PTL2-BS adjacent thereto and crossing each other. That is, in an embodiment, each of the emission areas PXA-B, PXA-G and PXA-R may not overlap the pattern lines PTL1-US, PTL2-US, PTL1-BS and PTL2-BS but be disposed in a rectangular shape defined by the pattern lines PTL1-US, PTL2-US, PTL1-BS and PTL2-BS disposed adjacent to each of the emission areas PXA-B, PXA-G and PXA-R.

The electronic device ED according to an embodiment may minimize a difference between a quantity of light, which is emitted from the emission areas PXA-B, PXA-G and PXA-R of the display module and passes through portions the pattern lines PTL1-US, PTL2-US, PTL1-BS and PTL2-BS, and a quantity of light, which is emitted from the emission areas PXA-B, PXA-G and PXA-R of the display module and passes through a portion of the oblique surface PTL-S (see FIG. 11), thereby exhibiting excellent display quality without the moire phenomenon and the unevenness phenomenon due to the difference in quantity of light.

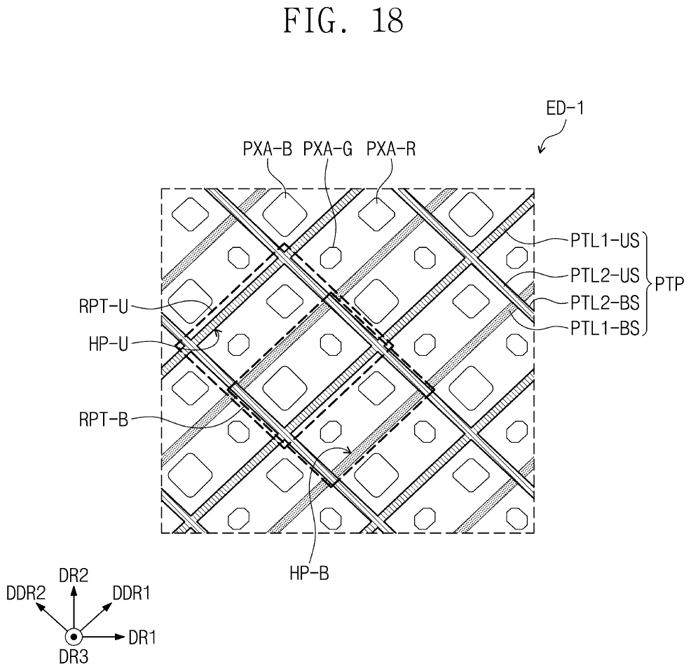

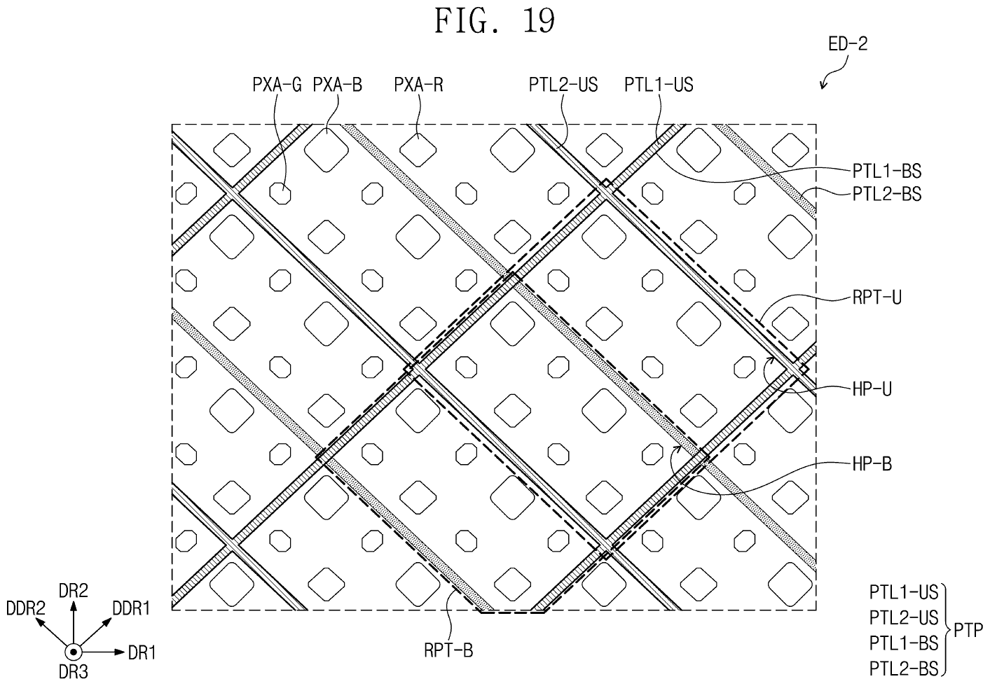

The electronic devices ED-1 and ED-2 according to an embodiment illustrated in FIGS. 18 and 19 is partially different from the electronic device ED illustrated in FIG. 17 in terms of an arrangement gap and an arrangement shape of patterns lines.

Also, in embodiments illustrated in FIGS. 18 and 19, a lower groove HP-B defined by a lower pattern RPT-B that is a second rectangular pattern may at least partially overlap an upper pattern RPT-U defined by an upper pattern RPT-U that is a first rectangular pattern. Accordingly, some of emission areas surrounded by the upper pattern RPT-U may be also surrounded by the lower pattern RPT-B.

In an embodiment illustrated in FIG. 18, a first upper pattern line PTL1-US and a first lower pattern line PTL1-BS may be alternately arranged in the second diagonal direction DDR2. A second upper pattern line PTL2-US and a second lower pattern line PTL2-BS may be alternately arranged in the first diagonal direction DDR1.

Referring to FIG. 18, in an embodiment, the upper pattern RPT-U and the lower pattern RPT-B, which are disposed to neighbor in the second diagonal direction DDR2 and partially overlap each other in the third direction DR3, may overlap each other so as to surround the same first emission area PXA-B and the same second emission area PXA-G, or overlap each other so as to surround the same third emission area PXA-R and the same second emission area PXA-G.

In an embodiment illustrated in FIG. 19, a second upper pattern line PTL2-US and a second lower pattern line PTL2-BS may be alternately arranged in the first diagonal direction DDR1. A first upper pattern line PTL1-US and a first lower pattern line PTL1-BS may be alternately arranged in the second diagonal direction DDR2.

Referring to FIG. 19, in an embodiment, an upper pattern RPT-U and a lower pattern RPT-B, which are disposed to neighbor in the first diagonal direction DDR1 and partially overlap each other in the third direction DR3, may overlap each other so as to surround a plurality of the same first emission areas PXA-B, a plurality of the same second emission areas PXA-G, and a plurality of the same third emission areas PXA-R.

In embodiments illustrated in FIGS. 17 to 19, a rectangular pattern defined by the upper pattern lines and a rectangular pattern defined by the lower pattern lines may each be arranged in a shape which surrounds at least one emission area.

In embodiments illustrated in FIGS. 17 to 19, the arrangement shapes of the pattern lines are examples, and an embodiment is not limited thereto. In an embodiment, some of the upper pattern lines and some of the lower pattern lines may be disposed so as to overlap the emission area. The electronic device according to an embodiment may minimize a difference between a quantity of light, which is emitted from the emission areas of the display module and passes through portions of the pattern lines, and a quantity of light which is emitted from the emission areas of the display module and passes through a portion of the oblique surface, thereby exhibiting excellent display quality without the moire phenomenon and the unevenness phenomenon due to the difference in quantity of light.

The arrangement shape of the pattern lines is an example, and an embodiment is not limited thereto. The rectangular pattern defined by the upper pattern lines and the rectangular pattern defined by the lower pattern lines may each be arranged in a shape which surrounds a plurality of emission areas. Also in this case, a quantity of emitted light, which is emitted from the emission areas and passes through the window, is not significantly different between an area on which the pattern lines are disposed and an area between the pattern lines. Accordingly, the electronic device according to an embodiment may minimize the difference in quantity of light in the entirety of the display surface, thereby exhibiting excellent display quality.

The electronic device according to an embodiment may minimize a difference between a quantity of light, which is emitted from the emission areas PXA-B, PXA-G and PXA-R of the display module and passes through portions of the pattern lines PTL1-US, PTL2-US, PTL1-BS and PTL2-BS, and a quantity of light, which is emitted from the emission areas PXA-B, PXA-G and PXA-R and passes through the oblique surface PTL-S (see FIG. 11), thereby exhibiting excellent display quality without the moire phenomenon and the unevenness phenomenon due to the difference in quantity of the light.

A window according to an embodiment may include a pattern portion in which a groove, which is recessed from each of the top surface and the bottom surface and has a rectangular pyramid shape or a truncated rectangular pyramid shape as a three-dimensional shape, is defined, thereby exhibiting a good folding characteristic and a characteristic in which a deviation in light transmittance of the entirety of the pattern portion is minimized. Accordingly, a distribution difference of light emitted after passing through the window according to an embodiment may be small to exhibit excellent visibility and optical characteristics.

An electronic device according to an embodiment may include the window according to an embodiment, which is disposed on a display module and includes the pattern portion in which the groove, which is recessed from each of the top surface and the bottom surface and has the rectangular pyramid shape or the truncated rectangular pyramid shape as the three-dimensional shape, is defined, thereby exhibiting excellent display quality.

The window according to the embodiment may include the pattern portion in which the grooves each having the rectangular pyramid shape or the truncated rectangular pyramid shape are defined and alternately arranged in the folding portion, thereby maintaining the excellent folding characteristic and also exhibiting the excellent optical characteristics in which the difference in light transmittance in the thickness direction is minimized.

The electronic device according to the embodiment may include the window including the pattern portion which defines the plurality of grooves each having the three-dimensional shape that is the rectangular pyramid shape or the truncated rectangular pyramid shape, thereby exhibiting the excellent folding characteristic and exhibiting the excellent display quality.

Although the embodiments of the present invention have been described, it is understood that the present invention should not be limited to these embodiments but various changes and modifications can be made by one ordinary skilled in the art within the spirit and scope of the present invention as hereinafter claimed.

Therefore, the technical scope of the invention is not limited to the contents described in the detailed description of the specification, but should be determined by the claims.

What is claimed is:

1. A window comprising:
a folding portion comprising a pattern portion defining a plurality of grooves recessed from each of a top surface and a bottom surface of the window, and a filling part filling the grooves;
a first non-folding portion disposed at one side of the folding portion; and
a second non-folding portion disposed apart from the first non-folding portion with the folding portion therebetween in a certain direction,
wherein each of the grooves has a quadrangular rectangular pyramid shape or a truncated rectangular pyramid shape.

2. The window of claim 1, wherein, on the top surface or the bottom surface, a shape of each of the grooves is rectangular in a plan view.

3. The window of claim 1, wherein the grooves comprise an upper groove recessed from the top surface, and a lower groove recessed from the bottom surface,
wherein the upper groove and the lower groove have a same three-dimensional shape.

4. The window of claim 3, wherein an upper portion of the upper groove, which has a rectangular shape, is defined in the top surface, and a lower portion of the upper groove is disposed adjacent to the bottom surface, and
a lower portion of the lower groove, which has a rectangular shape, is defined in the bottom surface, and an upper portion of the lower groove is disposed adjacent to the top surface,
wherein the lower portion of the upper groove and the upper portion of the lower groove which are adjacent to each other do not overlap each other in a plan view.

5. The window of claim 1, wherein the pattern portion comprises a plurality of pattern lines defining the grooves in the top surface or the bottom surface, and an oblique surface extending from the top surface to the bottom surface so as to define sides of the grooves.

6. The window of claim 5, wherein, on a cross-section perpendicular to the top surface or the bottom surface, the pattern portion has a zigzag pattern proceeding by repeated turns between the top surface and the bottom surface.

7. The window of claim 5, wherein, on a cross-section perpendicular to the top surface or the bottom surface, the oblique surface has a tilt angle of about 40° to about 55° with respect to the top surface or the bottom surface.

8. The window of claim 1, wherein, on a cross-section perpendicular to the top surface or the bottom surface, the pattern portion has a thickness of about 30 micrometers (μm) to about 40μ m.

9. The window of claim 8, wherein, on a cross-section perpendicular to the top surface or the bottom surface, a deviation in thickness of the pattern portion in a direction perpendicular to the top surface or the bottom surface is about 15 μm or less.

10. The window of claim 1, wherein each of the first non-folding portion and the second non-folding portion has a thickness of about 150 μm to about 400 μm.

11. The window of claim 1, wherein a width of the folding portion in the certain direction is about 4% to about 25% of a total width of the window in the certain direction.

12. The window of claim 1, further comprising a protective layer disposed on at least one of the top surface or the bottom surface.

13. An electronic device comprising:
a display module comprising a folding display portion changed into a folded or non-folded state, and a non-folding display portion adjacent to the folding display portion; and
a window disposed on the display module, and comprising a folding portion corresponding to the folding display portion, and a non-folding portion corresponding to the non-folding display portion,
wherein the folding portion comprises a pattern portion defining a plurality of grooves recessed from each a top surface and a bottom surface of the window, and a filling part filling the grooves,
wherein each of the grooves has a rectangular pyramid shape or a truncated rectangular pyramid shape.

14. The electronic device of claim 13, wherein the display module comprises a plurality of emission areas spaced apart from each other in a plan view,
wherein each of the grooves has a rectangular shape which surrounds at least one of the emission areas on the top surface or the bottom surface in the plan view.

15. The electronic device of claim 13, wherein the pattern portion comprises a plurality of pattern lines defining the grooves in the top surface or the bottom surface, and an oblique surface extending from the top surface to the bottom surface so as to define sides of the grooves,
wherein, on a cross-section perpendicular to the top surface or the bottom surface, the pattern portion has a zigzag pattern proceeding by repeated turns between the top surface and the bottom surface.

16. The electronic device of claim 13, wherein the grooves comprise an upper groove recessed from the top surface, and a lower groove recessed from the bottom surface,
wherein the upper groove and the bottom surface have a same three-dimensional shape.

17. The electronic device of claim 16, wherein a lower portion of the upper groove is adjacent to the bottom surface, and an upper portion of the lower groove is adjacent to the top surface,
wherein the lower portion of the upper groove and the upper portion of the lower groove do not overlap each other in a plan view.

18. The electronic device of claim 16, wherein the pattern portion, which defines the upper groove, comprises a plurality of first upper pattern lines extending in a first diagonal direction on the top surface, and a plurality of second upper pattern lines extending in a second diagonal direction crossing the first diagonal direction on the top surface, and
the pattern portion, which defines the lower groove, comprises a plurality of first lower pattern lines extending in the first diagonal direction on the bottom surface, and a plurality of second lower pattern lines extending in the second diagonal direction on the bottom surface.

19. The electronic device of claim 18, wherein the first upper pattern lines are arranged to be spaced apart from each other in the second diagonal direction, and
the first lower pattern lines are arranged to be spaced apart from each other in the second diagonal direction and alternately arranged with the first upper pattern lines in a plan view.

20. The electronic device of claim 18, wherein a first rectangular pattern, which is defined in the top surface by two of the first upper pattern lines neighboring each other in the second diagonal direction and two of the second upper pattern lines neighboring each other in the first diagonal direction, at least partially overlap a second rectangular pattern, which is defined in the bottom surface by two of the first lower pattern lines neighboring each other in the second diagonal direction and two of the second lower pattern lines neighboring each other in the first diagonal direction.
